(19) United States
(12) Patent Application Publication
(10) Pub. No.: US 2024/0070918 A1
(43) Pub. Date: Feb. 29, 2024

(54) CALIBRATION METHODS AND SYSTEMS FOR IMAGING FIELD

(71) Applicant: SHANGHAI UNITED IMAGING HEALTHCARE CO., LTD., Shanghai (CN)

(72) Inventor: Yanyan LIU, Shanghai (CN)

(73) Assignee: SHANGHAI UNITED IMAGING HEALTHCARE CO., LTD., Shanghai (CN)

(21) Appl. No.: 18/488,012

(22) Filed: Oct. 16, 2023

Related U.S. Application Data
(63) Continuation of application No. PCT/CN2022/087408, filed on Apr. 18, 2022.

(30) Foreign Application Priority Data
Apr. 16, 2021 (CN) 202110414431.2
Apr. 16, 2021 (CN) 202110414435.0
Apr. 16, 2021 (CN) 202110414441.6

(51) Int. Cl. G06T 7/80; G06T 5/20

(52) U.S. Cl. CPC G06T 7/80; G06T 5/20

(57) ABSTRACT

The present disclosure may provide a calibration system and a method for imaging field. The method may include obtaining a calibration model of a target imaging device. The calibration model may include at least one convolutional layer, and the at least one convolutional layer may include at least one candidate convolution kernel. The method may also include determining a target convolution kernel based on the at least one candidate convolution kernel of the calibration model. The method may also include determining calibration information of the target imaging device based on the target convolution kernel. The calibration information may be used to calibrate at least one of a device parameter of the target imaging device or imaging data acquired by the target imaging device.

### CROSS-REFERENCE TO RELATED APPLICATION

This application is a Continuation of International Application No. PCT/CN2022/087408, filed on Apr. 18, 2022, which claims priority to Chinese Patent Application No. 202110414441.6, filed on Apr. 16, 2021, Chinese Patent Application No. 202110414435.0, filed on Apr. 16, 2021, and Chinese Patent Application No. 202110414431.2, filed on Apr. 16, 2021, the contents of each of which are hereby incorporated by reference.

### TECHNICAL FIELD

The present disclosure generally relates to imaging field, and in particular, to calibration systems and methods for medical imaging.

### BACKGROUND

When an imaging device (e.g., an X-ray scanning device, a computed tomography (CT) device, a positron emission tomography-computed tomography (PET-CT) device) is used to scan and image a human body, an animal, or other objects, there may be some error factors resulting in inaccurate imaging data acquired by the scanning and imaging. Common error factors may include a mechanical deviation of a component of the imaging device (e.g., a positional deviation between an installation position and an ideal position of a detector, a positional deviation between an installation position and an ideal position of a radiation source of the detector), crosstalk between multiple detection units of the detector, scattering during the scanning of the imaging device (defocusing of the ray source (e.g., an X-ray tube), ray scattering caused the scanned object), etc. Therefore, it is desirable to provide a calibration method and system for imaging field.

### SUMMARY

An aspect of the present disclosure may provide a calibration method for imaging field. The calibration method may include: obtaining a calibration model of a target imaging device, wherein the calibration model may include at least one convolutional layer, the at least one convolutional layer may include at least one candidate convolution kernel; determining a target convolution kernel based on the at least one candidate convolution kernel of the calibration model; and determining calibration information of the target imaging device based on the target convolution kernel. The calibration information may be used to calibrate at least one of a device parameter of the target imaging device or imaging data acquired by the target imaging device.

In some embodiments, the calibration information may include at least one of mechanical deviation information of the target imaging device, crosstalk information of the target imaging device, or scattering information of the target imaging device.

In some embodiments, the determining the target convolution kernel based on the at least one candidate convolution kernel of the calibration model may include: determining the target convolution kernel by convolving the at least one candidate convolution kernel.

In some embodiments, the determining a target convolution kernel based on the at least one candidate convolution kernel of the calibration model may include: determining an input matrix based on the size of the at least one candidate convolution kernel; and determining the target convolution kernel by inputting the input matrix into the calibration model.

In some embodiments, the calibration model may be generated by a model training process. The model training process may include: obtaining first projection data of a reference object, wherein the first projection data is acquired by the target imaging device, and the first projection data includes deviation projection data; obtaining second projection data of the reference object, wherein the second projection data excludes the deviation projection data; determining training data based on the first projection data and the second projection data, and generating the calibration model by training a preliminary model using the training data.

In some embodiments, the generating the calibration model by training a preliminary model using the training samples may include one or more iterations. At least one of the one or more iterations may include: determining an intermediate convolution kernel of an updated preliminary model generated in a previous iteration; determining a value of a loss function based on the first projection data, the second projection data, and the intermediate convolution kernel; and further updating the updated preliminary model to be used in a next iteration based on the value of the loss function.

In some embodiments, the determining a value of a loss function based on the first projection data, the second projection data, and the intermediate convolution kernel may include: determining the value of the loss function based on at least one of a value of a first loss function and a value of a second loss function. The value of the first loss function may be determined based on the intermediate convolution kernel. The value of the second loss function may be determined based on the first projection data and the second projection data.

In some embodiments, the target imaging device may include a detector. The detector may include a plurality of detection units. The calibration information may include a positional deviation of a target detection unit among the plurality of detection units. The determining calibration information of the target imaging device based on the target convolution kernel may include: determining at least one first difference between a central element of the target convolution kernel and at least one other element of the target convolution kernel; determining at least one second difference between a projection position of the target detection unit and at least one projection position of at least one other detection unit of the detector; and determining the positional deviation of the target detection unit based on the at least one first difference and the at least one second difference.

In some embodiments, the target imaging device may include a radiation source. The calibration information may include mechanical deviation information of the radiation source.

In some embodiments, the target imaging device may include a detector. The detector may include a plurality of detection units. The calibration information may include a crosstalk coefficient of a target detection unit among the plurality of detection units. The determining calibration information of the target imaging device based on the target convolution kernel may include: determining, based on at least one difference between a central element of the target convolution kernel and at least one other element of the target convolution kernel, at least one crosstalk coefficient of the at least one other element with respect to the target detection unit.

In some embodiments, the at least one other element may include at least two other elements in a same target direction. The determining calibration information of the target imaging device based on the target convolution kernel may further include: determining a first crosstalk coefficient of the target detection unit in the target direction based on a sum of the crosstalk coefficients of the at least two other elements with respect to the target detection unit.

In some embodiments, the determining calibration information of the target imaging device based on the target convolution kernel may further include: determining a second crosstalk coefficient of the target detection unit in the target direction based on a difference between the crosstalk coefficients of the at least two other elements with respect to the target detection unit.

In some embodiments, the calibration information may include scattering information of the target imaging device. The determining calibration information of the target imaging device based on the target convolution kernel may include: determining scattering information of the target imaging device corresponding to at least one angle of view based on the target convolution kernel.

In some embodiments, the calibration model may also include a first activation function and a second activation function. The first activation function may be used to transform input data of the calibration model from projection data to data of a target type. The data of the target type may be input to the at least one convolutional layer for processing. The second activation function may be used to transform output data of the at least one convolutional layer from the data of the target type to projection data.

In some embodiments, the calibration model may also include a fusion unit, and the fusion unit may be configured to fuse the input data and the output data of the at least one convolutional layer.

In some embodiments, the calibration information the target imaging device may include calibration information relating to defocusing of the target imaging device. The calibration model may also include a data transformation unit. The data transformation unit may be configured to transform the data of the first target type to determine transformed data. The transformed data may be input to the at least one convolutional layer for processing.

Another aspect of the present disclosure may provide a calibration system for imaging field. The system may include at least one storage medium storing a set of instructions; at least one processor in communication with the at least one storage medium, when executing the stored set of instructions, the at least one processor may cause the system to: obtain a calibration model of a target imaging device, wherein the calibration model includes at least one convolutional layer, the at least one convolutional layer includes at least one candidate convolution kernel; determine a target convolution kernel based on the at least one candidate convolution kernel of the calibration model; and determine calibration information of the target imaging device based on the target convolution kernel. The calibration information may be used to calibrate at least one of a device parameter of the target imaging device or imaging data acquired by the target imaging device.

In some embodiments, the calibration information may include at least one of mechanical deviation information of the target imaging device, crosstalk information of the target imaging device, or scattering information of the target imaging device.

In some embodiments, to determine the target convolution kernel based on the at least one candidate convolution kernel of the calibration model, the at least one processor may cause the system to: determine the target convolution kernel by convolving the at least one candidate convolution kernel.

In some embodiments, to determine a target convolution kernel based on the at least one candidate convolution kernel of the calibration model, the at least one processor may cause the system to: determine an input matrix based on the size of the at least one candidate convolution kernel; and determine the target convolution kernel by inputting the input matrix into the calibration model.

In some embodiments, the calibration model may be generated by a model training process. The model training process may include: obtaining first projection data of a reference object, wherein the first projection data is acquired by the target imaging device, and the first projection data includes deviation projection data; obtaining second projection data of the reference object, wherein the second projection data excludes the deviation projection data; determining training data based on the first projection data and the second projection data, and generating the calibration model by training a preliminary model using the training data.

In some embodiments, to generate the calibration model by training a preliminary model using the training samples may include one or more iterations. At least one of the one or more iterations may include: determining an intermediate convolution kernel of an updated preliminary model generated in a previous iteration; determining a value of a loss function based on the first projection data, the second projection data, and the intermediate convolution kernel; and further updating the updated preliminary model to be used in a next iteration based on the value of the loss function.

In some embodiments, to determine a value of a loss function based on the first projection data, the second projection data, and the intermediate convolution kernel, the at least one processor may cause the system to: determine the value of the loss function based on at least one of a value of a first loss function and a value of a second loss function. The value of the first loss function may be determined based on the intermediate convolution kernel, and the value of the second loss function may be determined based on the first projection data and the second projection data.

In some embodiments, the target imaging device may include a detector. The detector may include a plurality of detection units. The calibration information may include a positional deviation of a target detection unit among the plurality of detection units. To determine calibration information of the target imaging device based on the target convolution kernel, the at least one processor may cause the system to: determine at least one first difference between a central element of the target convolution kernel and at least one other element of the target convolution kernel; determine at least one second difference between a projection position of the target detection unit and at least one projection position of at least one other detection unit of the detector; and determine the positional deviation of the target detection unit based on the at least one first difference and the at least one second difference.

In some embodiments, the target imaging device may include a radiation source. The calibration information may include mechanical deviation information of the radiation source.

In some embodiments, the target imaging device may include a detector. The detector may include a plurality of detection units. The calibration information may include a crosstalk coefficient of a target detection unit among the plurality of detection units. To determine calibration information of the target imaging device based on the target convolution kernel, the at least one processor may cause the system to: determine, based on at least one difference between a central element of the target convolution kernel and at least one other element of the target convolution kernel, at least one crosstalk coefficient of the at least one other element with respect to the target detection unit.

In some embodiments, at least one other element may include at least two other elements in a same target direction. To determine calibration information of the target imaging device based on the target convolution kernel, the at least one processor may further cause the system to: determine a first crosstalk coefficient of the target detection unit in the target direction based on a sum of the crosstalk coefficients of the at least two other elements with respect to the target detection unit.

In some embodiments, to determine calibration information of the target imaging device based on the target convolution kernel, the at least one processor may further cause the system to: determine a second crosstalk coefficient of the target detection unit in the target direction based on a difference between the crosstalk coefficients of the at least two other elements with respect to the target detection unit.

In some embodiments, the calibration information may include scattering information of the target imaging device. To determine calibration information of the target imaging device based on the target convolution kernel, the at least one processor may cause the system to: determine scattering information of the target imaging device corresponding to at least one angle of view based on the target convolution kernel.

In some embodiments, the calibration model may also include a first activation function and a second activation function. The first activation function may be used to transform input data of the calibration model from projection data to data of a target type. The data of the target type may be input to the at least one convolutional layer for processing. The second activation function may be used to transform output data of the at least one convolutional layer from the data of the target type to projection data.

In some embodiments, the calibration model may also include a fusion unit, and the fusion unit may be configured to fuse the input data and the output data of the at least one convolutional layer.

In some embodiments, the calibration information the target imaging device may include calibration information relating to defocusing of the target imaging device. The calibration model may also include a data transformation unit. The data transformation unit may be configured to transform the data of the first target type to determine transformed data, and the transformed data may be input to the at least one convolutional layer for processing.

A further aspect of the present disclosure may relate to a non-transitory computer readable medium. The non-transitory computer readable medium may include executable instructions that, when executed by at least one processor, causing the at least one processor to effectuate a method comprising: obtaining a calibration model of a target imaging device, wherein the calibration model may include at least one convolutional layer, the at least one convolutional layer may include at least one candidate convolution kernel; determining a target convolution kernel based on the at least one candidate convolution kernel of the calibration model; and determining calibration information of the target imaging device based on the target convolution kernel. The calibration information may be used to calibrate at least one of a device parameter of the target imaging device and imaging data acquired by the target imaging device.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary application scenario of a calibration system of an imaging device according to some embodiments of the present disclosure;

FIG. 2 is a block diagram illustrating an exemplary calibration system of an imaging device according to some embodiments of the present disclosure;

FIG. 3 is a flowchart illustrating an exemplary calibration method of an imaging device according to some embodiments of the present disclosure;

FIG. 4 is a schematic diagram illustrating an exemplary input matrix according to some embodiments of the present disclosure;

FIG. 5 is a flowchart illustrating an exemplary calibration method of an imaging device according to some other embodiments of the present disclosure;

FIG. 6 is a flowchart illustrating an exemplary method for determining mechanical deviation information of a device to be calibrated based on a target convolution kernel according to some embodiments of the present disclosure;

FIG. 7 is a schematic diagram illustrating an exemplary method for determining a target convolution kernel based on a pixel matrix of first projection data according to some embodiments of the present disclosure;

FIG. 8 is a flowchart illustrating an exemplary calibration method of an imaging device according to some embodiments of the present disclosure;

FIG. 9 is a flowchart illustrating an exemplary method for determining crosstalk information of a device to be calibrated based on a target convolution kernel according to some embodiments of the present disclosure;

FIG. 10 is a schematic diagram illustrating an exemplary pixel matrix of detection units and a corresponding target convolution kernel according to some embodiments of the present disclosure;

FIG. 11 is a schematic diagram illustrating an exemplary structure of a crosstalk calibration model according to some embodiments of the present disclosure;

FIG. 12 is a schematic diagram illustrating exemplary images obtained before and after crosstalk calibration according to some embodiments of the present disclosure;

FIG. 13 is a flowchart illustrating an exemplary calibration method of an imaging device according to some other embodiments of the present disclosure;

FIG. 14 is a schematic diagram illustrating an exemplary defocusing according to some embodiments of the present disclosure;

FIG. 15 is a schematic diagram illustrating an exemplary structure of a defocusing calibration model according to some embodiments of the present disclosure; and

FIG. 16 is a schematic diagram illustrating an exemplary structure of a scattering calibration model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is to describe particular example embodiments only and is not intended to be limiting. As used herein, the singular forms “a,” “an,” and “the” may be intended to include the plural forms as well, unless the context indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” or “block,” as used herein, may refer to logic embodied in hardware or firmware, or to a collection of software instructions. A module or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an Electrically Programmable Read-Only-Memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It may be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The function and method of operation of these and other features, characteristics, and related structural elements of the present application, as well as component combinations and manufacturing economy, may become more apparent from the following description of the accompanying drawings, which constitute part of the specification of this application. It should be understood, however, that the drawings are for purposes of illustration and description only and are not intended to limit the scope of the present disclosure. It should be understood that the drawings are not to scale.

For purposes of illustration, the following description is provided to assist in a better understanding of the imaging process. It should be noted that the above description is merely provided for the purposes of illustration, and not intended to limit the scope of the present disclosure. For those of ordinary skill in the art, a certain number of alterations, alterations and/or modifications may be deducted under the guidance of this application. However, those variations and modifications do not depart from the scope of the present disclosure.

The present disclosure may provide a calibration method and system for imaging field. The system may obtain a calibration model of a target imaging device. The calibration model may include at least one convolution layer. The at least one convolution layer may include at least one candidate convolution kernel. The system may also determine a target convolution kernel based on the at least one candidate convolution kernel of the calibration model. The system may also determine calibration information of the target imaging device based on the target convolution kernel. The calibration information may be used to calibrate a device parameter of the target imaging device or imaging data acquired by the target imaging device. For example, the calibration model may include one or more of a mechanical deviation calibration model, a crosstalk calibration model, or a scattering calibration model.

In some embodiments of the present disclosure, the calibration model of the target imaging device may be generated by training a preliminary model using training samples. In conventional model training method, it may be necessary to train the preliminary model based on a large number of training samples such that all model parameters of the calibration model may meet requirements or tend to be stable, and the calibration model generated so may have a better calibration effect. The calibration method and system provided in the present disclosure may achieve the calibration by determining the calibration information of the target imaging device based on the target convolution kernel. The target convolution kernel may be determined based on the at least one candidate convolution kernel of the calibration model. The at least one candidate convolution kernel of the calibration model may only be a part of model parameters in the calibration model. The calibration method and system provided in the present disclosure may train the preliminary model based on a relatively small number of training samples to generate the calibration model with a stable candidate convolution kernel, and further determine a stable target convolution kernel based on the calibration model. Therefore, by utilizing the calibration method and system provided in the present disclosure, the calibration effect may be improved while the efficiency is improved and a required computational resource is reduced, and the practicability may be strong.

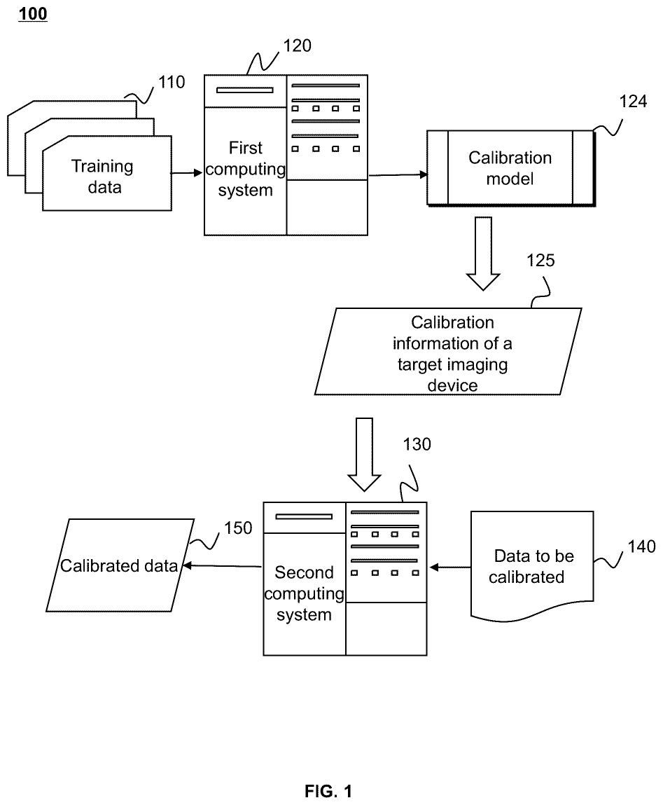

FIG. 1 is a schematic diagram illustrating an exemplary calibration system 100 according to some embodiments of the present disclosure. As shown in FIG. 1, the calibration system 100 may include a first computing system 120 and a second computing system 130.

The first computing system 120 may obtain training data 110, and generate one or more calibration models 124 by training one or more preliminary models using the training data 110. The calibration model(s) 124 may be configured to calibrate a device parameter of a target imaging device and/or imaging data acquired by the target imaging device. For example, the calibration model(s) 124 may include a mechanical deviation calibration model, a crosstalk calibration model, a scattering model, etc. In some embodiments, the training data 110 may include first projection data and second projection data of a reference object. The first projection data may include deviation projection data. The second projection data may exclude the deviation projection data. The deviation projection data may refer to error data caused by one or more error factors, for example, a mechanical deviation of an imaging device, crosstalk between detection units of the imaging device, a scattering phenomenon during a scan, etc. In some embodiments, the second projection data may be acquired by a standard imaging device 1 that has been subjected to an error calibration (e.g., a mechanical deviation calibration). Alternatively, the second projection data may be acquired by calibrating the first projection data.

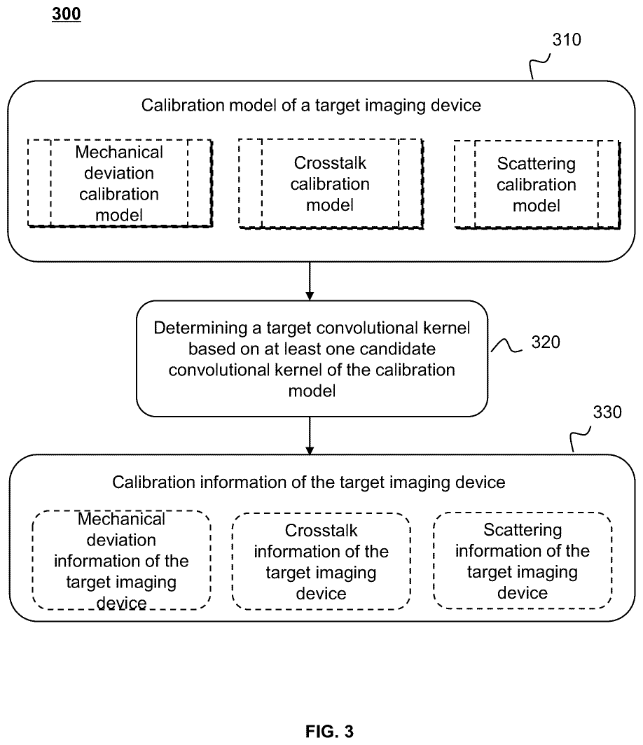

Detailed descriptions of the training data and the calibration model(s) may be found in FIG. 3-FIG. 16 and the descriptions thereof, which are not repeated here.

In some embodiments, the first computing system 120 may further determine calibration information 125 of the target imaging device, for example, mechanical deviation information, crosstalk information, scattering information, etc. In some embodiments, the first computing system 120 may determine one or more target convolution kernels based on the one or more calibration model 124 and determine the calibration information 125 based on the one or more target convolution kernels. Detailed descriptions of the calibration information may be found in FIG. 3-FIG. 16 and the descriptions thereof, which are not repeated here.

The second computing system 130 may calibrate data to be calibrated 140 of the target imaging device based on the calibration information of the target imaging device to determine calibrated data 150. The data to be calibrated 140 may include a device parameter of the target imaging device (e.g., a positional parameter of a detection unit), imaging data acquired by the target imaging device, etc. For example, the data to be calibrated 140 may include the device parameter of the target imaging device (e.g., the positional parameter of a detection unit), and the second computing system 130 may calibrate the device parameter of the target imaging device based on the mechanical deviation information of the target imaging information to determine a calibrated device parameter of the target imaging device. As another example, the data to be calibrated 140 may include the imaging data acquired by the target imaging device, and the second computing device may calibrate the imaging data based on the crosstalk information of the target imaging device and/or the scattering information of the target imaging device to determine calibrated imaging data.

In some embodiments, the first computing system 120 and the second computing system 130 may be the same or different. In some embodiments, the first computing system 120 and the second computing system 130 may refer to a system with computing capability. In some embodiments, the first computing system 120 and the second computing system 130 may include various computers, such as a server, a personal computer, etc. In some embodiments, the first computing system 120 and the second computing system 130 may also be a computing platform including multiple computers connected in various structures.

In some embodiments, the first computing system 120 and the second computing system 130 may include a processor. In some embodiments, the processor may execute program instructions. In some embodiments, the processor may include various common general-purpose central processing units (CPU), graphics processing units (GPU), microprocessor units (MPU), application-specific integrated circuits (ASIC), or other types of integrated circuits.

In some embodiments, the first computing system 120 and the second computing system 130 may include a storage medium. In some embodiments, the storage medium may store instructions and data. The storage medium may include a mass storage, a removable storage, a volatile read-write memory, a read-only memory (ROM), etc., or any combination thereof.

In some embodiments, the first computing system 120 and the second computing system 130 may include a network for internal and external connections. In some embodiments, the network may be any one or more of a wired network or a wireless network.

In some embodiments, the first computing system 120 and the second computing system 130 may include a terminal for input or output. In some embodiments, the terminal may include various types of devices with information receiving and/or sending functions, such as a computer, a mobile phone, a text scanning device, a display device, a printer, etc.

The description of the calibration system 100 is intended to be illustrative, not to limit the scope of the present disclosure. For persons having ordinary skills in the art, multiple variations and modifications may be made under the teachings of the present disclosure. For example, the first computing system 120 and the second computing system 130 may be integrated into a single device. As another example, the calibration information 125 of the target imaging device may be determined by the second computing system 130 based on the calibration model 124. However, those variations and modifications do not depart from the scope of the present disclosure.

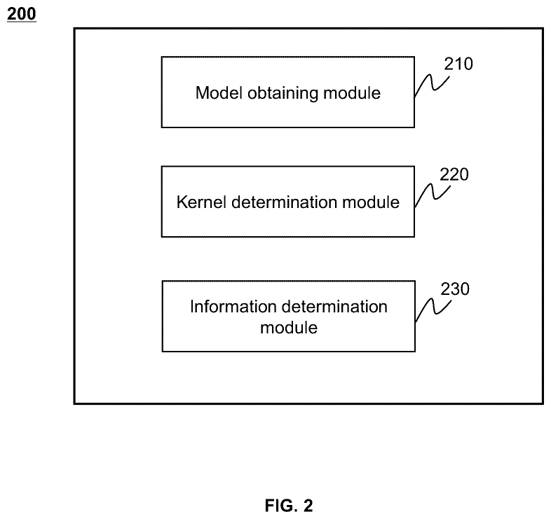

FIG. 2 is a block diagram illustrating an exemplary processing device 200 according to some embodiments of the present disclosure. In some embodiments, the processing device 200 may be implemented on the first computing system 120 and/or the second computing system 130. In some embodiments, the processing device 200 may include a model obtaining module 210, a kernel determination module 220, and an information determination module 230.

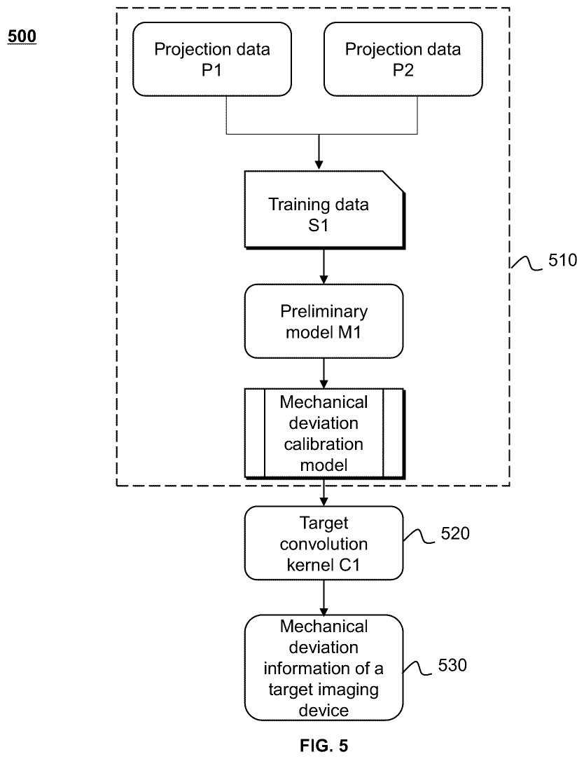

The model obtaining module 210 may be configured to obtain a calibration model of the target imaging device. The target imaging device may be an imaging device that needs to be calibrated. The calibration model may refer to a model configured to determine calibration information. The calibration information may be used to calibrate the target imaging device and/or imaging data acquired by the target imaging device (e.g., projection data and/or image data reconstructed based on the projection data). In some embodiments, the calibration model may include one or more of a mechanical deviation calibration model, a crosstalk calibration model, or a scattering calibration model. The mechanical deviation calibration model may be configured to calibrate deviation projection data caused by a mechanical deviation in the projection data acquired by the target imaging device. The crosstalk calibration model may be configured to calibrate deviation projection data caused by crosstalk in the projection data acquired by the target imaging device. The scattering calibration model may be configured to calibrate deviation projection data caused by scattering in the projection data acquired by the target imaging device. More descriptions of the calibration model and/or the target imaging device may be found elsewhere in the present disclosure, for example, FIGS. 5-16 and the descriptions thereof.

The kernel determination module 220 may be configured to determine a target convolutional kernel based on the at least one candidate convolutional kernel of the calibration model. The target convolution kernel may refer to a convolution kernel used to calibrate a device parameter of the target imaging device and/or the imaging data acquired by the target imaging device. In some embodiments, when the calibration model includes one candidate convolution kernel, the one candidate convolution kernel may be used as the target convolution kernel. In some embodiments, when the calibration model includes multiple candidate convolution kernels, the kernel determination module 220 may determine one convolution kernel based on the multiple candidate convolution kernels, and the determined convolution kernel may be used as the target convolution kernel. More descriptions of the determination of the target convolutional kernel may be found elsewhere in the present disclosure, for example, FIG. 3 and the descriptions thereof.

The information determination module 230 may be configured to determine calibration information of the target imaging device based on the target convolution kernel. The calibration information may be used to calibrate at least one of the target imaging device and the imaging data acquired by the target imaging device. More descriptions of the calibration information may be found elsewhere in the present disclosure, for example, FIG. 3 and the descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the system may include one or more other modules. Optionally, one or more modules of the above-described system may be omitted.

FIG. 3 is a flowchart illustrating an exemplary calibration method of an imaging device according to some embodiments of the present disclosure. In some embodiments, one or more operations in the process 300 shown in FIG. 3 may be implemented in the calibration system 100 shown in FIG. 1. For example, the process 300 in FIG. 3 may be stored in a storage medium of the first computing system 120 and/or the second computing system 130 in the form of instructions, and be invoked and/or executed by a processing device of the first computing system 120 and/or the second computing system 130. In some embodiments, the process 300 shown in FIG. 3 may be performed by the processing device 200 shown in FIG. 2. For illustration purposes, the processing device 200 may be used as an example to describe the execution of the process 300 below.

In some embodiments, a device parameter of each detection unit of a target imaging device or imaging data acquired by each detection unit may be calibrated respectively according to the process 300.

In 310, the processing device 200 may obtain a calibration model of the target imaging device. In some embodiments, operation 310 may be performed by the model obtaining module 210.

The target imaging device may be an imaging device that needs to be calibrated. The target imaging device may include any imaging device configured to scan an object, such as a CT device, a PET device, etc. In some embodiments, the target imaging device may include a radiography device, such as an X-ray imaging device, a CT device, a PET-CT device, a laser imaging device, etc. In some embodiments, the object may include a human body or a part thereof (e.g., a specific organ or tissue), an animal, a phantom, etc. The phantom may be used to simulate an actual object to be scanned (e.g., the human body). In some embodiments, absorption or scattering of radiation by the phantom may be the same as or similar to that of the actual object to be scanned. In some embodiments, the phantom may be made of a non-metallic material or a metallic material. The metallic material may include copper, iron, nickel, an alloy, etc. The non-metallic material may include an organic material, an inorganic material, etc. The phantom may be a geometry of various shapes, such as a point geometry, a line geometry, or a surface geometry. In some embodiments, the shape of the phantom may have a gradient, e.g., the shape of the phantom may be an irregular polygon.

In some embodiments, the target imaging device may perform a common scan or a special scan of the object. The common scan may include a transverse scan, a coronal scan, etc. The special scan may include a localization scan, a thin-layer scan, a magnification scan, a target scan, a high-resolution scan, etc.

In some embodiments, the target imaging device may include a radiation source (e.g., an X-ray tube) and a detector. When an imaging device scans and images the object, the radiation source may emit a radiation ray (e.g., an X-ray, a gamma ray, etc.), and the radiation ray may be received by the detector after passing through the imaged object. The detector may generate response data (such as projection data) in response to the received ray. In some embodiments, the detector may include a plurality of detection units, which may form a matrix. For the convenience of description, a target detection unit and one or more detection units surrounding the target detection unit may be defined as a detection unit matrix in the present disclosure. The target detection unit may refer to a detection unit that requires a calibration (e.g., a mechanical deviation calibration, a scattering calibration). For example, the target detection unit and the one or more detection units surrounding the target detection unit may be arranged as a row, i.e., a 1×n detection unit matrix (n may be an integer greater than 0). As another example, the target detection unit and the one or more detection units surrounding the target detection unit may be arranged as multiple rows, i.e., an m×n detection unit matrix (m may be an integer greater than 1). In some embodiments, the target detection unit may be located at a center of the detection unit matrix.

In some embodiments, the response data acquired by the detector may include projection data. In some embodiments, the projection data acquired by the target imaging device may include projection data acquired by the detection unit matrix formed by the target detection unit and the one or more detection units surrounding the target detection unit. In some embodiments, projection data acquired by one detection unit may correspond to one pixel. The projection data acquired by the detection unit matrix may correspond to a pixel matrix. For example, projection data acquired by a 3×3 detection unit matrix may correspond to a 3×3 pixel matrix.

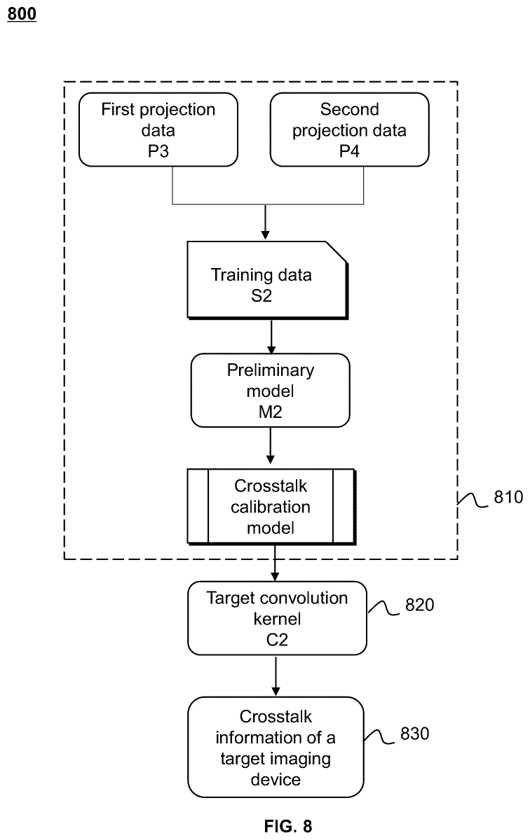

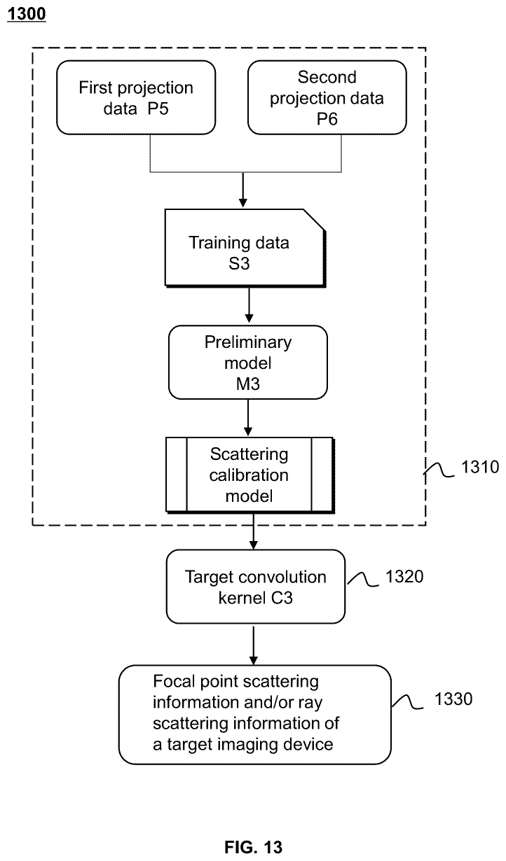

The calibration model may refer to a model configured to determine calibration information. The calibration information may be used to calibrate the target imaging device and/or the imaging data acquired by the target imaging device (e.g., projection data and/or image data reconstructed based on the projection data). In some embodiments, the calibration model may include one or more of a mechanical deviation calibration model, a crosstalk calibration model, or a scattering calibration model. The mechanical deviation calibration model may be configured to calibrate deviation projection data caused by a mechanical deviation in the projection data acquired by the target imaging device. The crosstalk calibration model may be configured to calibrate deviation projection data caused by crosstalk in the projection data acquired by the target imaging device. The scattering calibration model may be configured to calibrate deviation projection data caused by scattering in the projection data acquired by the target imaging device. Detailed descriptions of the mechanical deviation calibration model may be found in FIG. 5-FIG. 7 and the descriptions thereof. Detailed descriptions of the crosstalk calibration model may be found in FIG. 8-FIG. 12 and the descriptions thereof. Detailed descriptions of the scattering calibration model may be found in FIG. 13-FIG. 16 and the descriptions thereof.

In some embodiments, the calibration model may include a convolutional neural network model. The convolutional neural network model may include at least one convolutional layer. Each convolutional layer may include at least one convolution kernel. In the present disclosure, a convolution kernel included in the calibration model may be referred to as a candidate convolution kernel.

In some embodiments, the size of a candidate convolution kernel may be the same as the size of the detection unit matrix of the target imaging device. For example, the detector of the target imaging device may include a 3×3 detection unit matrix, and the size of the candidate convolution kernel may be 3×3. As another example, the detector of the target imaging device may include a 1×12 detection unit matrix, and the size of the candidate convolution kernel of the calibration model may be 1×12. In some embodiments, the size of the candidate convolution kernel may be non-limiting, and set according to experiences or actual requirements.

In some embodiments, in addition to the at least one convolutional layer, the calibration model may also include other network structures, for example, an activation function layer, a data transformation layer (such as a linear transformation layer, a nonlinear transformation layer), a fully connected layer, etc. For example, the calibration model may include an input layer, x convolutional layers, and an output layer. As another example, the calibration model may include an input layer, a first activation function layer, x convolutional layers, a second activation function layer, and an output layer. x may be an integer greater than or equal to 1. As a further example, the calibration model may include an input layer, a first activation function layer, a data transformation layer, x convolutional layers, a second activation function layer, and an output layer. x may be an integer greater than or equal to 1. Detailed descriptions of the structure of the calibration model may be found in FIG. 5-FIG. 16 and the descriptions thereof.

In some embodiments, the calibration model may be generated by training a preliminary model using training data. Detailed descriptions of the training of the preliminary model may be found in FIG. 5, FIG. 8, FIG. 13, and the descriptions thereof.

In 320, the processing device 200 may determine a target convolutional kernel based on the at least one candidate convolutional kernel of the calibration model. In some embodiments, operation 320 may be performed by the kernel determination module 220.

The target convolution kernel may refer to a convolution kernel used to calibrate a device parameter of the target imaging device and/or the imaging data acquired by the target imaging device.

In some embodiments, the size of the target convolution kernel may be the same as the size of the detection unit matrix of the target detection unit. For example, if the size of the detection unit matrix is 3×3, the size of the target convolution kernel may be 3×3. As another example, if the size of the detection unit matrix is 1×12, the size of the target convolution kernel of the calibration model may be 1×12.

In some embodiments, when the calibration model includes one candidate convolution kernel, the one candidate convolution kernel may be used as the target convolution kernel. In some embodiments, when the calibration model includes multiple candidate convolution kernels, one convolution kernel may be determined based on the multiple candidate convolution kernels, and the determined convolution kernel may be used as the target convolution kernel.

For example, the processing device 200 may perform a convolution operation on the multiple candidate convolution kernels to determine the target convolution kernel. For example, the calibration model may include three 3×3 candidate convolution kernels A, B, and C, and the convolution operation may be performed on the three candidate convolution kernels (which may be expressed as A*B*C, wherein * may represent the convolution operation) to determine a 3×3 target convolution kernel. As another example, the calibration model may include one 3×3 candidate convolution kernel A, two 5×5 candidate convolution kernels B1 and B2, one 7×7 candidate convolution kernel C, and the convolution operation may be performed on the four candidate convolution kernels (which may be expressed as A*B1*B2*C, wherein * may represent the convolution operation) to determine a 3×3 target convolution kernel.

As another example, the processing device 200 may determine an input matrix based on the size of the target convolution kernel, and input the input matrix into the calibration model. Based on the input matrix, the calibration model may output multiple elements used to determine the target convolution kernel. In some embodiments, the input matrix may have the same size as the target convolution kernel. For example, the size of the target convolution kernel may be 4×4, and the size of the input matrix may also be 4×4. As another example, the size of the target convolution kernel may be 1×4, and the size of the input matrix may also be 1×4.

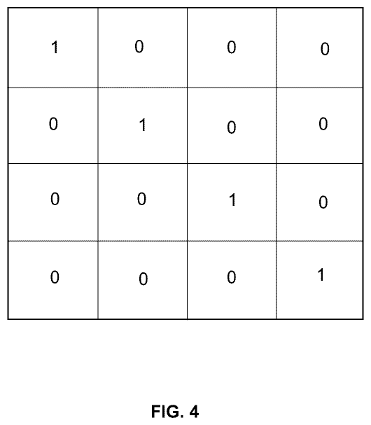

In some embodiments, in each row of the input matrix, only one element may be 1, and the remaining elements may be 0. In this case, the input matrix may be input into the calibration model, and a model output may include a response corresponding to a position where the element is 1 in each row, and the response may be used as an element value of the corresponding position in the target convolution kernel. For example, as shown in FIG. 4A, the input matrix may be a 4×4 matrix, in which an n^{th} element of a n^{th} row may be 1 (0<n<5), and the remaining elements may be 0. An input matrix shown in FIG. 4 may be input into the calibration model, and the calibration model may output a response corresponding to a first element of a first row of the input matrix (corresponding to an element value of a first element of a first row of the target convolution kernel), a response corresponding to a second element of a second row of the input matrix (corresponding to an element value of a second element of a second row of the target convolution kernel), a response corresponding to a third element of a third row of the input matrix (corresponding to an element value of a third element of a third row of the target convolution kernel), and a response corresponding to a fourth element of a fourth row of the input matrix (corresponding to an element value of a fourth element of a fourth row of the target convolution kernel).

In some embodiments, the remaining elements in the target convolution kernel other than the n^{th} element in the n^{th} row may be 0 (0<n). For example, when scattering calibration is performed, remaining elements in a desired target convolution kernel other than an n^{th} element of an n^{th} row may be 0, and the input matrix may be determined accordingly, wherein the n^{th} element of the n^{th} row may be 1, and the remaining elements may be 0. At this time, the input matrix may be input into the calibration model, and an element value of the n^{th} element in the n^{th} row of the target convolution kernel may be determined. In some embodiments, each row in the input matrix may be equivalent to an impulse function.

In some embodiments, multiple input matrices may be determined, and a position of an element with a value of 1 in each input matrix may be different. In some embodiments, the multiple input matrices may be input into the calibration model, respectively, and the calibration model may output a response corresponding to the position where the element is 1 in each row of each input matrix. The response may be an element value of the corresponding position in the target convolution kernel, such that all element values corresponding to all positions in the target convolution kernel may be determined.

In some embodiments, different calibration models may determine different target convolution kernels. For example, a target convolution kernel C1 may be determined based on the mechanical deviation calibration model, a target convolution kernel C2 may be determined based on the crosstalk calibration model, and a target convolution kernel C3 may be determined based on the scattering calibration model.

In 330, the processing device 200 may determine calibration information of the target imaging device based on the target convolution kernel. The calibration information may be used to calibrate at least one of the target imaging device or the imaging data acquired by the target imaging device. In some embodiments, operation 330 may be performed by the information determination module 230.

In some embodiments, different calibration information may be determined based on different target convolution kernels corresponding to different calibration models.

For example, position deviation information of one or more components (such as a detection unit, a ray source) of the target imaging device may be determined based on the target convolution kernel C1 corresponding to the mechanical deviation calibration model. In some embodiments, the mechanical deviation information may be used to calibrate the mechanical deviation of the target imaging device and/or the imaging data acquired by the target imaging device. Detailed descriptions of the mechanical deviation information may be found in FIG. 5-FIG. 7 and the descriptions thereof.

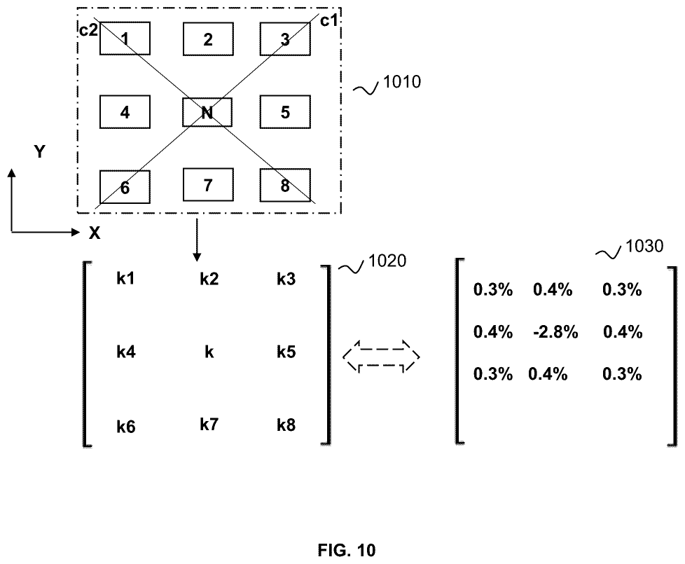

As another example, crosstalk information between multiple detection units of the target imaging device may be determined based on the target convolution kernel C2 corresponding to the crosstalk calibration model. In some embodiments, the crosstalk information may be used to calibrate the imaging data acquired by the target imaging device. Detailed descriptions of the crosstalk information may be found in FIG. 8 and FIG. 10 and the descriptions thereof.

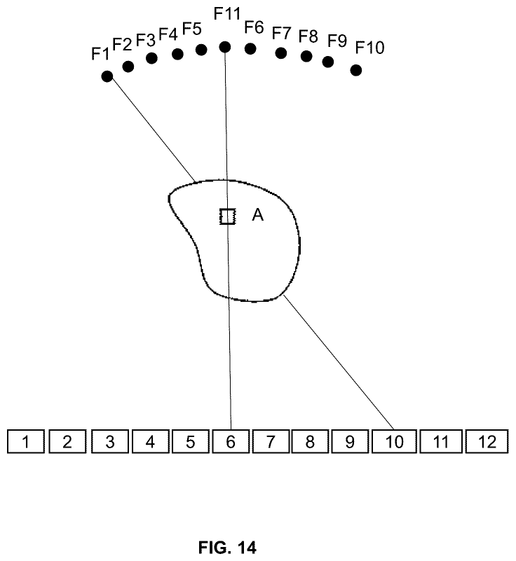

As further another example, scattering information may be determined based on the target convolution kernel C3 corresponding to the scattering calibration model. In some embodiments, the scattering information may be used to calibrate the imaging data acquired by the target imaging device. Detailed descriptions of the scattering information may be found in FIG. 13-FIG. 14 and the descriptions thereof.

In some embodiments, the processing device 200 may determine calibration information relating to the target detection unit of the target imaging device based on the calibration model.

FIG. 5 is a flowchart illustrating an exemplary calibration process of an imaging device according to some embodiments of the present disclosure. In some embodiments, one or more operations in the process 500 shown in FIG. 5 may be implemented in the calibration system 100 shown in FIG. 1. For example, the process 500 shown in FIG. 5 may be stored in a storage medium of the first computing system 120 and/or the second computing system 130 in the form of instructions, and be invoked and/or executed by a processing device of the first computing system 120 and/or the second computing system 130. In some embodiments, the process 500 shown in FIG. 5 may be performed by the processing device 200 shown in FIG. 2. For illustration purposes, the processing device 200 may be used as an example to describe the execution of the process 500 below.

In some embodiments, the process 500 may be used to calibrate a mechanical deviation of each detection unit of a target imaging device or deviation projection data caused by the mechanical deviation. For illustration purposes, how to perform the process 500 on a target detection unit of the target imaging device may be described below.

In 510, the processing device 200 may obtain a mechanical deviation calibration model of the target imaging device. In some embodiments, operation 510 may be performed by the model obtaining module 210.

The mechanical deviation of the target imaging device may include a positional deviation between an actual installation position (also referred to as an actual position) and an ideal position of a component of the target imaging device. For example, the mechanical deviation may include a positional deviation of the target detection unit of the target imaging device. As another example, the mechanical deviation may include a positional deviation of a radiation source (e.g., an X-ray tube) of the target imaging device. The mechanical deviation calibration model may be configured to calibrate deviation projection data caused by a mechanical deviation in projection data acquired by the target imaging device. In some embodiments, the mechanical deviation calibration model may be configured to calibrate a positional deviation of the target detection unit and/or deviation projection data caused by the positional deviation of the target detection unit.

In some embodiments, the mechanical deviation calibration model may include at least one convolutional layer.

In some embodiments, the mechanical deviation calibration model may be pre-generated by the processing device 200 or other processing devices. For example, the processing device 200 may obtain projection data P1 of a reference object and projection data P2 of the reference object. Further, the processing device 200 may determine training data S1 based on the projection data P1 and the projection data P2, and use the training data S1 to train a preliminary model M1 to generate the mechanical deviation calibration model.

The projection data P1 may include projection data acquired by the target imaging device by scanning the reference object. For example, the target detection unit of the target imaging device may have a mechanical deviation, and the projection data P1 may include projection data acquired by a detection unit matrix corresponding to the target detection unit. Due to the mechanical deviation of the target imaging device (or the target detection unit), the projection data P1 may include deviation projection data caused by the mechanical deviation. The reference object may refer to a scanned object used to obtain the training data. In some embodiments, the reference object may include a phantom.

The projection data P2 may include projection data acquired by a standard imaging device 1 by scanning the reference object. For example, the projection data P2 may include projection data acquired by a detection unit matrix corresponding to a standard detection unit of the standard imaging device 1. The standard detection unit may be located at the same position as the target detection unit of the target imaging device. The size and structure of the detection unit matrix of the standard detection unit may be the same as the size and structure of the detection unit matrix of the target detection unit. In the present disclosure, the standard imaging device 1 may be an imaging device without mechanical deviation or having a mechanical deviation within an acceptable range. For example, the standard imaging device 1 may have been subjected to mechanical deviation calibration using other existing mechanical deviation calibration techniques (e.g., a manual calibration technique or other traditional mechanical deviation calibration techniques).

In some embodiments, the target imaging device and the standard imaging device 1 may be devices of the same type. For example, if the types of the detector, the counts of detection units, and the arrangements of the detection units of two imaging devices are the same, the two imaging devices may be deemed as being of the same type. In some embodiments, the projection data P1 may be acquired by a reference imaging device of the same type as the target imaging device, wherein the reference imaging device may have not been subjected to mechanical deviation calibration.

In some embodiments, the projection data P1 and the projection data P2 may be acquired in the same scanning manner. In some embodiments, if two sets of projection data are acquired based on the same scanning parameters, they may deem to be acquired in the same scanning manner. For example, the target imaging device and the standard imaging device 1 may scan the same reference object based on the same ray intensity, the same scanning angle, and the same rotational speed to acquire the projection data P1 and the projection data P2, respectively.

In some embodiments, the projection data P1 and/or the projection data P2 may be acquired based on an existing calibration manner or a simulated manner. For example, the projection data P1 may be acquired by scanning the reference object using the target imaging device, and the corresponding projection data P2 may be determined based on the projection data P1 using the existing calibration manner or the simulated manner. For example, the projection data P2 may be acquired by scanning the reference object using the standard imaging device 1, and the corresponding projection data P1 may be determined based on the projection data P2 using the existing calibration manner or the simulated manner.

In some embodiments, the target imaging device may scan the reference object multiple times to acquire the projection data P1 relating to each detection unit in the detector. In some embodiments, the standard imaging device 1 may also scan the reference object multiple times to acquire the projection data P2 relating to each detection unit in the detector. In some embodiments, a position of the reference object in each of the multiple scans may be different, for example, the reference object may be located at a center of a gantry of the target imaging device, 10 centimeters off the center of the gantry (also referred to as off-center), 20 centimeters off the center of the gantry, or the like.

In some embodiments, the training of the preliminary model M1 using the projection data P1 and the projection data P2 as the training data may include one or more iterations. In the one or more iterations, the processing device 200 may designate the projection data P1 as an input of the model, designate the projection data P2 as gold standard data, and iteratively update a model parameter of the preliminary model M1. For example, in a current iteration, the processing device 200 may determine an intermediate convolution kernel C1 of an updated preliminary model MI generated in a previous iteration. It should be noted that if the current iteration is a first iteration, the processing device 200 may determine an intermediate convolution kernel of the preliminary model M1. The intermediate convolution kernel C′1 may be determined based on at least one candidate convolution kernel of the preliminary model M1 or the updated preliminary model M1′. The method for determining the intermediate convolution kernel based on the candidate convolution kernel(s) of the preliminary model M1 or the updated preliminary model M1′ may be similar to the method for determining the target convolution kernel based on the candidate convolution kernel(s) of the calibration model. See, FIG. 3 and the descriptions thereof.

The processing device 200 may further determine a value of a loss function F12 based on the first projection data P1, the second projection data P2, and the intermediate convolution kernel C′1. In some embodiments, the processing device 200 may determine a value of a first loss function F1 based on the intermediate convolution kernel C′1. The processing device 200 may determine a value of a second loss function F2 based on the first projection data P1 and the second projection data P2. Further, the processing device 200 may determine the value of the loss function F12 based on the value of the first loss function F1 and the value of the second loss function F2.

For example, the first loss function F1 may be used to measure a difference between an element value of a central element of the intermediate convolution kernel C′1 and a preset value a. The central element of the intermediate convolution kernel C′1 may refer to an element at a central position of the intermediate convolution kernel C′1. In some embodiments, the preset value a may be 1. In some embodiments, the difference between the central element of the intermediate convolution kernel C1 and the preset value a may include an absolute value, a square difference, etc. The second loss function F2 may be used to measure a difference between a predicted output of the updated preliminary model M1′ (i.e., an output after inputting the first projection data P1 into M1′) and the corresponding gold standard data (i.e., the corresponding second projection data P2).

The value of the loss function F12 may be determined based on the value of the first loss function F1 and the value of the second loss function F2. For example, the value of the loss function F12 may be a sum or a weighted sum of the first loss function F1 and the second loss function F2. After the value of the loss function F12 is determined, the processing device 200 may further update the updated preliminary model MI to be used in a next iteration based on the value of the loss function F12. In some embodiments, the processing device 200 may only determine the value of the second loss function F2 and further update the updated preliminary model MI to be used in the next iteration based on the value of the second loss function F2. In some embodiments, a goal of the model parameter adjustment of the training of the preliminary model M1 may include minimizing a difference between the prediction output and the corresponding gold standard data, i.e., minimizing the value of the second loss function F2. In some embodiments, the goal of the model parameter adjustment of the training of the preliminary model M1 may include minimizing a difference between the element value of the central element of the intermediate convolution kernel C′1 and the preset value a, i.e., minimizing the value of the first loss function F1.

In some embodiments, the mechanical deviation calibration model may be generated by training the preliminary model using a model training technique, for example, a gradient descent technique, a Newton technique, etc. In some embodiments, if a preset stop condition is satisfied in a certain iteration for updating the preliminary model M1, the training of the preliminary model M1 may be completed. The preset stop condition may include a convergence of the loss function F12 or the second loss function F2 (for example, a difference between the values of the loss function F12 in two consecutive iterations or a difference between the values of the second loss function F2 in two consecutive iterations smaller than a first threshold) or the result of the loss function F12 or the second loss function F2 smaller than a second threshold, a count of the iterations in the training exceeding a third threshold, etc.

In 520, the processing device 200 may determine a target convolution kernel C1 based on at least one candidate convolution kernel of the mechanical deviation calibration model. In some embodiments, operation 510 may be performed by the kernel determination module 220.

A target convolution kernel determined based on the at least one candidate convolution kernel of the mechanical deviation calibration model may be referred to as the target convolution kernel C1. Detailed descriptions of the method for determining the target convolution kernel based on the at least one candidate convolution kernel of the calibration model may be found in operation 320 and the descriptions thereof, which are not repeated here.

In 530, the processing device 200 may determine mechanical deviation information of the target imaging device based on the target convolution kernel C1. In some embodiments, operation 530 may be performed by the information determination module 230.

The mechanical deviation information may include positional deviation information of one or more components (e.g., the target detection unit, the radiation source) of the target imaging device. In some embodiments, the positional deviation information may include positional deviation information of the one or more components (e.g., the target detection unit) of the target imaging device in one or more directions.

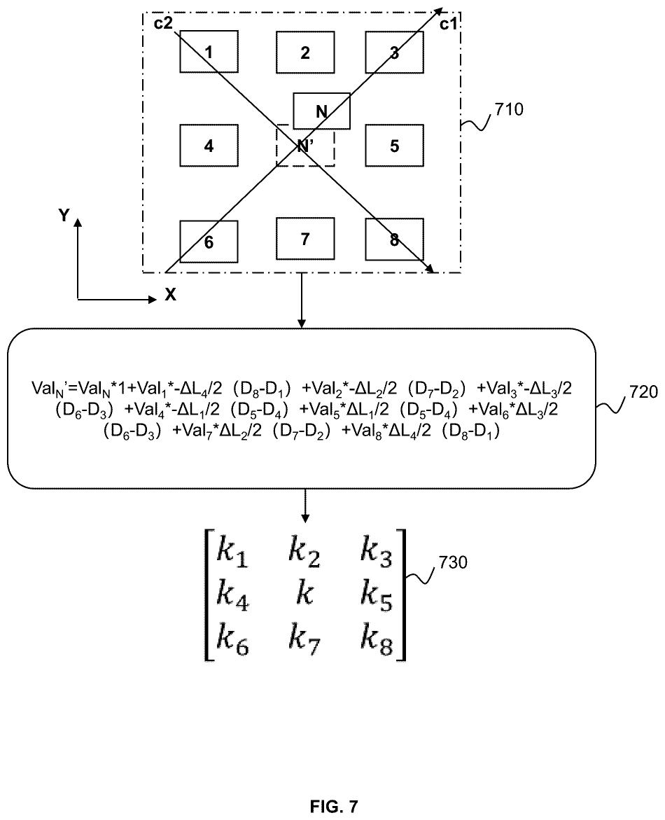

Taking the target detection unit of the target imaging device as an example, the position deviation information thereof may include a position deviation of the target detection unit in at least one direction, and the position deviation may be determined based on the target convolution kernel C1. For example, FIG. 7 shows a detection unit matrix 710 centered in a target detection unit. The detection unit matrix 710 may include 9 detection units 1, 2, 3, 4, 5, 6, 7, 8, and N, which are arranged along the directions X and Y. The detection unit N may be the target detection unit, and an actual installation position (represented by a solid rectangle in FIG. 7) of the detection unit N deviates from an ideal position (represented by a dotted rectangle N′ in FIG. 7) of the detection unit N. The position deviation information of the target detection unit N may include deviation distances of the actual position and the ideal position in a direction X, a direction Y, a diagonal direction c1, and a diagonal direction c2 of the detection unit matrix 710.

As mentioned above, the trained mechanical deviation calibration model (including the at least one candidate convolution kernel) may be configured to calibrate the deviation projection data caused by the position deviation of the target detection unit. The calibration of the deviation projection data by the mechanical deviation calibration model may be mainly realized based on the at least one candidate convolution kernel. Thus, the at least one candidate convolution kernel of the mechanical deviation calibration model may be used to determine information relating to the calibration of the mechanical deviation. Some embodiments of the present disclosure may determine the target convolution kernel C1 based on the at least one candidate convolution kernel, and determine the mechanical deviation information of the target imaging device based on the target convolution kernel C1. In some embodiments, the greater the count of the candidate convolution kernel(s) included in the mechanical deviation calibration model is, the more accurate the information relating to the mechanical deviation calibration included in the target convolution kernel C1 that is determined based on the at least one candidate convolution kernel may be, and the better effect of the mechanical deviation calibration based on the target convolution kernel C1 may be. Some embodiments provided in the present disclosure use the deep learning technique to learn the calibration process of the deviation projection data, which has higher calibration accuracy and efficiency than a traditional calibration technique.

FIG. 7 shows the detection unit matrix 710 corresponding to the target detection unit N and the target convolution kernel C1-730 simultaneously. The principle and method for determining the position deviation information of the target detection unit N based on the target convolution kernel C1-730 may be described below with reference to FIG. 7. The projection data P1 of the training data of the mechanical deviation calibration model may include projection data (also referred to as response data) acquired by the detection unit matrix 710. The size of the target convolution kernel C1-730 determined based on the mechanical deviation calibration model may be the same as the size of the detection unit matrix 710, both being 3×3. As shown in FIG. 7, the target convolution kernel C1-730 may include elements k, k₁, k₂, k₃, k₅, k₆, k₇, k₈, and a central element may be k. Actual response values of the detection units 1, 2, 3, 4, 5, 6, 7, 8, and N at their respective actual installation positions may be expressed as VaI₁, VaI₂, VaI₃, VaI₄, VaI₅, VaI₆, VaI₇, VaI₈, and VaI_{N}, respectively. An ideal response value when the target detection unit N is located at the ideal position N′ (i.e., the calibrated projection data determined after calibrating the deviation projection data caused by the position deviation) may be expressed as VaI_{N}′.

The ideal response value VaIN′ of the target detection unit N may be determined using linear interpolation. According to the actual response values and projection positions D₁, D₂, D₃, D₄, D₅, D₆, D₇, D₈ of the detection units 1-8, a slope along the direction X may be determined as k₁=(VaI₅−VaI₄)/(D₅−D₄), a slope along the direction Y may be determined as k₂=(VaI₇−VaI₂)/(D₇−D₂D), a slope along the direction c1 may be determined as k₃=(VaI₆−VaI₃)/(D₆−D₃), and a slope along the direction c2 may be determined as k₄=(VaI₈−VaI₁)/(D₈−D₁). The projection position of the detection unit may correspond to the actual installation position of the detection unit. The projection position may refer to a position of a projection of the detection unit under an incident ray. According to the slope k₁ and a positional deviation ΔL₁ between the actual installation position and the ideal position of the target detection unit N in the direction X, the deviation of the actual response value and the ideal response value of the target detection unit N in the direction X may be determined as ΔN1=k₁×ΔL₁. According to the slope k₂ and a position deviation ΔL₂ between the actual installation position and the ideal position of the target detection unit N in the direction Y, the deviation of the actual response value and the ideal response value of the target detection unit N in the direction Y may be determined as ΔN2=k₂×ΔL₂. According to the slope k₃ and a position deviation ΔL₃ between the actual installation position and the ideal position of the target detection unit N in the direction c1, the deviation of the actual response value of N and the ideal response value of the target detection unit N along the direction c1 may be determined as ΔN3=k₃×ΔL₃. According to the slope k₄ and a position deviation ΔL₄ between the actual installation position and the ideal position of the target detection unit N in the direction c2, the deviation of the actual response value and the ideal response value of the target detection unit N along the direction c2 may be determined as ΔN4=k₄×ΔL₄. Further, it may be determined that VaI_{N}′=VaI_{N}+(ΔN1+ΔN2+ΔN3+ΔN4)/2.

In some embodiments, VaI_{N}′=VaI_{N}+(ΔN1+ΔN2+ΔN3+ΔN4)/2 may further be expressed as a formula 720 shown in FIG. 7:

$${VaI}_{N}^{′} = {VaI}_{N} \times 1 + {VaI}_{1} \times - \frac{Δ {L}_{4}}{2 ( {D}_{8} - {D}_{1} )} + {VaI}_{2} \times - \frac{Δ {L}_{2}}{2 ( {D}_{7} - {D}_{2} )} + {VaI}_{3} \times - \frac{Δ {L}_{3}}{2 ( {D}_{6} - {D}_{3} )} + {VaI}_{4} \times - \frac{Δ {L}_{1}}{2 ( {D}_{5} - {D}_{4} )} + {VaI}_{5} \times \frac{Δ {L}_{1}}{2 ( {D}_{5} - {D}_{4} )} + {VaI}_{6} \times \frac{Δ {L}_{3}}{2 ( {D}_{6} - {D}_{3} )} + {VaI}_{7} \times \frac{Δ {L}_{2}}{2 ( {D}_{7} - {D}_{2} )} + {VaI}_{8} \times \frac{Δ {L}_{4}}{2 ( {D}_{8} - {D}_{1} )} .$$

In some embodiments, the aforementioned formula 720 for determining the ideal response value VaI_{N}′ of the target detection unit N may be equivalent to a convolution of the actual response values VaI₁″VaI_{N} with the target convolution kernel C1-730. Therefore, each element value of the target convolution kernel C1-730 may correspond to coefficients of VaI₁″VaI_{N} in the formula 720. For example, the central element k in the target convolution kernel C1-730 may correspond to a coefficient of the actual response value VaI_{N} of the target detection unit N in the formula 720, which may be 1 or close to 1. The element k₁ in the target convolution kernel C1-730 may correspond to

$$- \frac{Δ {L}_{4}}{2 ( {D}_{8} - {D}_{1} )} ,$$

the element k₂ may correspond to

$$- \frac{Δ {L}_{2}}{2 ( {D}_{7} - {D}_{2} )} ,$$

the element k₃ may correspond to

$$- \frac{Δ {L}_{3}}{2 ( {D}_{6} - {D}_{3} )} ,$$

the element k₄ may correspond to the element

$$- \frac{Δ {L}_{1}}{2 ( {D}_{5} - {D}_{4} )} ,$$

the element k₅ may correspond to

$$\frac{Δ {L}_{1}}{2 ( {D}_{5} - {D}_{4} )} ,$$

The element k₆ may correspond to

$$\frac{Δ {L}_{3}}{2 ( {D}_{6} - {D}_{3} )} ,$$

the element k₇ may correspond to

$$\frac{Δ {L}_{2}}{2 ( {D}_{7} - {D}_{2} )} ,$$

and the element k₈ may correspond to

$$\frac{Δ {L}_{4}}{2 ( {D}_{8} - {D}_{1} )} .$$

According to me above principles, it may be concluded that the position deviation information ΔL₁, ΔL₂, ΔL₃, and ΔL₄ of the target detection unit N may be determined based on each element of the target convolution kernel 730.

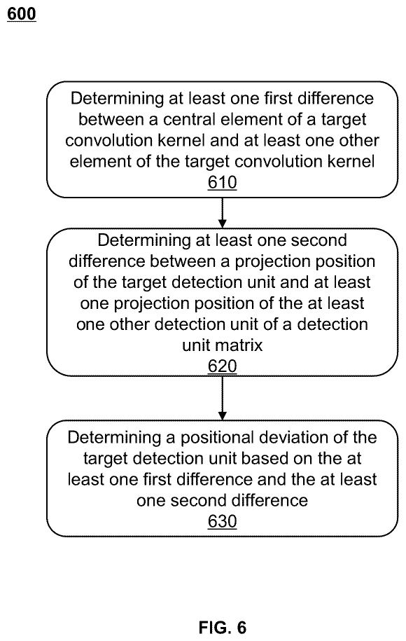

In some embodiments, the process 600 shown in FIG. 6 may be performed to determine the mechanical deviation information of the device to be calibrated based on the target convolution kernel.

In 610, the processing device 200 may determine at least one first difference between a central element of the target convolution kernel C1 and at least one other element of the target convolution kernel C1. In some embodiments, operation 610 may be performed by the information determination module 230.

A first difference may refer to a difference value between the central element of the target convolution kernel C1 and another element. The at least one other element may include all or part of elements other than the central element in the target convolution kernel C1. In some embodiments, the at least one other element may be located in at least one direction with respect to the central element. The at least one direction may refer to at least one direction in an element array of the target convolution kernel C1 or refer to at least one direction in the detection unit matrix (for example, the directions X, Y, c1, c2 shown in FIG. 7).

Taking the target convolution kernel C1-730 shown in FIG. 7 as an example, the at least one first difference may include differences (k₅−k) and (k−k₄) between the central element k and the elements k₄ and k₅ in the direction X, differences (k₇−k) and (k−k₂) between the central element k and the elements k₂ and k₇ in the direction Y, differences (k₆−k) and (k−k₃) between the central element k and the elements k₃ and k₆ in the direction c1, differences (k₈−k) and (k−k₁) between the central element k and the elements k₁ and k₈ in the direction c2.

In 620, the processing device 200 may determine at least one second difference between a projection position of the target detection unit and at least one projection position of at least one other detection unit of the detection unit matrix. In some embodiments, operation 620 may be performed by the information determination module 230.

A second difference may refer to a difference value between the projection position of the target detection unit and a projection position of another detection unit of the detection unit matrix. Taking the detection unit matrix 710 shown in FIG. 7 as an example, the at least one second difference may include differences (D₅−D_{N}) and (D_{N}−D₄) between the projection position of the target detection unit N and the projection positions of the detection units 4 and 5 in the direction X, differences (D₇−D_{N}) and (D_{N}−D₄) between the projection position of the target detection unit N and the projection positions of the detection units 2 and 7 in the direction Y, differences (D₆−D_{N}) and (D_{N}−D₃) between the projection position of the target detection unit N and the projection positions of the detection units 3 and 6 in the direction c1, and differences (D₈−D_{N}) and (D_{N}−D₁) between the projection position of the target detection unit N and the projection positions of the detection units 1 and 8 in the direction c2.

In 630, the processing device 200 may determine the positional deviation of the target detection unit based on the at least one first difference and the at least one second difference. In some embodiments, operation 630 may be performed by the information determination module 230.

The positional deviation of the target detection unit may include a positional deviation of the target detection unit the in at least one direction. Taking the detection unit matrix 710 shown in FIG. 7 as an example, the positional deviation of the target detection unit may include one or more of a position deviation in the direction X, a position deviation in the direction c1, a position deviation in the direction Y, or a position deviation in the direction c2.

In some embodiments, the positional deviation of the target detection unit in a certain direction may be determined based on a first difference corresponding to the center element of the target convolution kernel C1 in the direction and a second difference corresponding to the target detection unit in the direction. For example, the processing device 200 may determine a sum (k₅−k₄) of differences (k₅−k) and (k−k₄) between the center element and the elements k₄, k₅ in the direction X. The processing device 200 may also determine a sum (D₅−D₄) of differences (D₅−D_{N}) and (D_{N}−D₄) between the projection position of the target detection unit and the projection positions of the detection units in the direction X. The processing device 200 may further determine a position deviation of the target detection unit in the direction X as ΔL₁=(D₅−D₄)(k₅−k₄) based on the above-mentioned formula 720 for determining VaI_{N}′ by interpolation. The manner for determining the position deviation in the directions Y, c1, or c2 may be similar to the manner for determining the position deviation in the direction X. For example, a distance deviation of the target detection unit in the direction Y may be determined as ΔL₂=(D₇−D₂)(k₇−k₂), a distance deviation of the target detection unit in the direction c1 may be determined as ΔL₃=(D₆−D₃)(k₆−k₃), and a distance deviation of the target detection unit in the direction c2 may be determined as ΔL₄=(D₈−D₁)(k₈−k₁).

In some embodiments, in order to determine a positional deviation of the target detection unit in a certain direction, the processing device 200 may determine components of positional deviations of the target detection unit in multiple directions with respect to the direction, and further determine the positional deviation of the target detection unit in the direction based on the components. For example, taking FIG. 7 as an example, the distance deviation ΔL₁ of the target detection unit in the direction X may be determined based on the first differences and the second differences in the directions X, Y, c1, and c2 using the formula (1) below:

$$Δ {L}_{1} = \frac{1}{3} [ \text{} ( {D}_{5} - {D}_{4} ) ( {k}_{5} - {k}_{4} ) - \frac{\sqrt{2}}{2} ( {D}_{6} - {D}_{3} ) ( {k}_{6} - {k}_{3} ) + \frac{\sqrt{2}}{2} ( {D}_{8} - {D}_{1} ) ( {k}_{8} - {k}_{1} ) ] . \qquad ( 1 )$$

The distance deviation ΔL₂ of the target detection unit in the direction Y may be determined based on the first differences and the second differences in the directions X, Y, c1, and c2 using the formula (2) below:

$$Δ {L}_{2} = \frac{1}{3} [ \text{} ( {D}_{7} - {D}_{2} ) ( {k}_{7} - {k}_{2} ) + \frac{\sqrt{2}}{2} ( {D}_{6} - {D}_{3} ) ( {k}_{6} - {k}_{3} ) + \frac{\sqrt{2}}{2} ( {D}_{8} - {D}_{1} ) ( {k}_{8} - {k}_{1} ) ] . \qquad ( 2 )$$

The distance deviation ΔL₃ of the target detection unit in the direction c1 may be determined based on the first differences and the second differences in the directions X, Y, c1, and c2 using the formula (3) below:

$$Δ {L}_{3} = \frac{1}{3} [ \text{} ( {D}_{6} - {D}_{3} ) ( {k}_{6} - {k}_{3} ) - \frac{\sqrt{2}}{2} ( {D}_{5} - {D}_{4} ) ( {k}_{5} - {k}_{4} ) + \frac{\sqrt{2}}{2} ( {D}_{7} - {D}_{2} ) ( {k}_{7} - {k}_{2} ) ] . \qquad ( 3 )$$

The distance deviation ΔL₄ of the target detection unit in the direction c2 may be determined based on the first differences and the second differences in the directions X, Y, c1, and c2 using the formula (4) below:

$$Δ {L}_{4} = \frac{1}{3} [ \text{} ( {D}_{8} - {D}_{1} ) ( {k}_{8} - {k}_{1} ) + \frac{\sqrt{2}}{2} ( {D}_{5} - {D}_{4} ) ( {k}_{5} - {k}_{4} ) + \frac{\sqrt{2}}{2} ( {D}_{7} - {D}_{2} ) ( {k}_{7} - {k}_{2} ) ] . \qquad ( 4 )$$

In some embodiments, the process 600 may be applied to a detection unit matrix of an arbitrary size, for example, the size of the detection unit matrix may include 4×4, 4×5, 5×4, etc. In some embodiments, the process 600 may be used to perform a mechanical deviation calibration for a target detection unit located at an arbitrary position (e.g., a central position, an edge position).

It should be noted that the linear interpolation manner may be used as an example to illustrate how to determine the mechanical deviation information based on the target convolution kernel C1 in the descriptions above. Other than the linear interpolation manner, other manners (for example, a common interpolation manner such as Lagrangian interpolation) may also be used to determine the mechanical deviation information based on the target convolution kernel C1.

In some embodiments, a positional deviation between an actual installation position and an ideal position of the radiation source (e.g., the X-ray tube) of the target imaging device may also be determined according to the process 600. In some embodiments, the positional deviation of the radiation source may be equivalent to co-existing positional deviations of all detection units. In some embodiments, position deviation information Δ1-ΔN of all detection units 1″N of the target imaging device may be determined according to the process 600, respectively, and the position deviation information of the ray source of the target imaging device may be determined based on an average value of the position deviation information Δ1-ΔN of all detection units 1-N. For example, the position deviation information Δ_{tube} of the ray source of the target imaging device may be expressed as

$${Δ}_{tube} = \frac{1}{N} {\sum }_{i = 1}^{N} Δ i .$$

In some embodiments, the target imaging device may scan and image the object (e.g., a patient) to acquire projection data (including the deviation projection data corresponding to the mechanical deviation of the target imaging device). In some embodiments, the processing device 200 may calibrate the deviation projection data of the projection data acquired by the target imaging device based on the determined mechanical deviation information. For example, the calibration may include determining an ideal position (i.e., a position of the target detection unit after the positional deviation calibration) of the target detection unit based on the mechanical deviation information of the target detection unit and an actual installation position of each detection unit in the detection unit matrix corresponding to target detection unit. As another example, the calibration may include determining (for example, according to formula 720 in FIG. 7, or according to various other interpolation manners) an ideal response value of the target detection unit (i.e., the calibrated projection data after calibrating the deviation projection data caused by the position deviation) based on the mechanical deviation information of the target detection unit and an actual response value of each detection unit in the detection unit matrix corresponding to target detection unit. As used herein, the response value of a detection unit may correspond to a projection value acquired by the detection unit after receiving a ray. At this time, an actual response value of the target detection unit may include a response value of the target detection unit at its actual installation position, and the ideal response value of the target detection unit may include a response value of the target detection unit at its ideal position.

In some embodiments, the calibrated projection data may be used for image reconstruction to acquire a scanned image of the object.

In some embodiments, the device parameter of the target imaging device may be calibrated based on the mechanical deviation information of the target imaging device. For example, based on the positional deviation information of the target detection unit of the target imaging device, the processing device 200 may determine a direction and a distance that the target detection unit needs to move in order to move the target detection unit to the ideal position. As another example, based on the position deviation information of the ray source (e.g., the X-ray tube) of the target imaging device, the processing device 200 may determine a direction and a distance that the ray source (e.g., the X-ray tube) needs move to calibrate the ray source (e.g., the X-ray tube), such that the ray source may be moved to its ideal position.

FIG. 8 is a flowchart illustrating an exemplary crosstalk calibration process according to some embodiments of the present disclosure. In some embodiments, one or more operations of the process 800 shown in FIG. 8 may be implemented in the calibration system 100 shown in FIG. 1. For example, the process 800 shown in FIG. 8 may be stored in a storage medium of the first computing system 120 and/or the second computing system 130 in the form of instructions and revoked and/or executed by a processing device of the first computing system 120 and/or the second computing system 130. In some embodiments, the process 800 shown in FIG. 8 may be performed by the processing device 200 shown in FIG. 2. For illustration purposes, the processing device 200 may be used as an example to describe the execution of the process 800 below.

In some embodiments, the process 800 may be performed on multiple detection units of a target imaging device, respectively, to calibrate projection data acquired by each detection unit. For illustration purposes, how to perform the process 800 on a target detection unit of the target imaging device may be described below.

In 810, the processing device 200 may obtain a crosstalk calibration model of the target imaging device. In some embodiments, operation 810 may be performed by the model obtaining module 210.

Crosstalk may refer to mutual interference between detection units of an imaging device. For example, an X photon that deems to be received by a certain detection unit may spread to an adjacent detection unit. The crosstalk may cause contrast ratios in some positions of an image acquired by the target imaging device to decrease, and also cause an artifact of the image. In some embodiments, the crosstalk may involve multiple detection units (for example, the crosstalk may exist between multiple pairs of detection units in a detection unit matrix).

In some embodiments, when imaging data is acquired by performing a scan by the target imaging device, crosstalk may exist between detection units of the target imaging device, resulting in deviation projection data in the projection data. The crosstalk calibration model may be used to calibrate the deviation projection data caused by the crosstalk in the projection data acquired by the target imaging device. In some embodiments, the crosstalk calibration model may be used to calibrate deviation projection data caused by the crosstalk of a target detection unit.

In some embodiments, the crosstalk calibration model may be pre-generated by the processing device 200 or other processing devices. For example, the processing device 200 may obtain projection data P3 and projection data P4 of a reference object. Further, the processing device 200 may determine training data S2 based on the projection data P3 and the projection data P4, and train a preliminary model M2 based on the training data S2 to generate the crosstalk calibration model.

The projection data P3 may include projection data acquired by the target imaging device by scanning the reference object. For example, the target detection unit of the target imaging device may have crosstalk with a surrounding detection unit, and the projection data P3 may include projection data acquired by a detection unit matrix corresponding to the target detection unit. Due to the crosstalk of the target imaging device, the projection data P3 may include the deviation projection data caused by the crosstalk.

The projection data P4 may include projection data acquired by a standard imaging device 2 by scanning the reference object. For example, the projection data P4 may include projection data acquired by a detection unit matrix corresponding to a standard target detection unit of the standard imaging device 2. The position of the standard detection unit may be the same as the position of the target detection unit of the target imaging device. The size and the structure of the detection unit matrix of the standard detection unit may be the same as the size and the structure of the detection unit matrix of the target detection unit. In the present disclosure, the standard imaging device 2 may be an imaging device without crosstalk or having crosstalk within an acceptable range. For example, the standard imaging device 2 may have been subjected to crosstalk calibration using other existing crosstalk calibration techniques (e.g., a manual calibration technique or other traditional crosstalk calibration techniques).

In some embodiments, the target imaging device and the standard imaging device 2 may be devices of the same type. In some embodiments, the projection data P3 may be acquired by a reference imaging device of the same type as the target imaging device, wherein the reference imaging device may have not been subjected to crosstalk calibration. In some embodiments, the projection data P3 and the projection data P4 may be acquired in the same scanning manner.

In some embodiments, the target imaging device with crosstalk may scan the reference object multiple times to acquire the projection data P3 relating to each detection unit of the detector. In some embodiments, the standard imaging device 2 may also scan the reference object multiple times to acquire the projection data P4 relating to each detection unit of the detector. More information of the multiple scans may be found in FIG. 5 and the descriptions thereof.

In some embodiments, the projection data P3 and/or the projection data P4 may be obtained based on an existing calibration technique or a simulation technique. For example, the projection data P3 may be acquired by scanning the reference object based on an imaging device with crosstalk (e.g., the target imaging device or other imaging devices with mechanical deviation), and corresponding projection data P4 may be determined based on the projection data P3 using the existing calibration technique or the simulation technique. As another example, the projection data P4 may be acquired by scanning the reference object based on the standard imaging device 3, and the corresponding projection data P3 may be determined based on the projection data P4 using the existing calibration technique or the simulation technique.

In some embodiments, the training of the preliminary model M2 with the projection data P3 and the projection data P4 as the training data may include one or more iterations. In the one or more iterations, the processing device 200 may designate the projection data P3 as an input of the model, designate the projection data P4 as gold standard data, and iteratively update a model parameter of the preliminary model M2. For example, in a current iteration, the processing device 200 may determine an intermediate convolution kernel C′2 of an updated preliminary model M2′ generated in a previous iteration. It should be noted that if the current iteration is a first iteration, the processing device 200 may determine an intermediate convolution kernel of the preliminary model M2. The intermediate convolution kernel C′2 may be determined based on at least one candidate convolution kernel of the preliminary model M2 or the updated preliminary model M2′. The method for determining the intermediate convolution kernel based on the candidate convolution kernel(s) of the preliminary model M2 or the updated preliminary model M2′ may be similar to the method for determining the target convolution kernel based on the candidate convolution kernel(s) of the calibration model. See, FIG. 3 and the descriptions thereof.

The processing device 200 may further determine a value of a loss function F34 based on the first projection data P3, the second projection data P4, and the intermediate convolution kernel C′2. In some embodiments, the processing device 200 may determine a value of a first loss function F3 based on the intermediate convolution kernel C′2. The processing device 200 may determine a value of a second loss function F4 based on the first projection data P3 and the second projection data P4. Further, the processing device 200 may determine the value of the loss function F34 based on the value of the first loss function F3 and the value of the second loss function F4.

For example, the first loss function F3 may be used to measure a difference between a sum of values of respective elements in the intermediate convolution kernel C′2 and a preset value b. In some embodiments, the preset value b may be 0. In some embodiments, the difference between the sum of the values of the respective elements in intermediate convolution kernel C′2 and the preset value b may include an absolute value, a square difference, etc., of the difference between the sum and the preset value b. The second loss function F4 may be used to measure a difference between a predicted output of the updated preliminary model M2′ (i.e., an output after the first projection data P3 is input into M2′) and the corresponding gold standard data (i.e., the corresponding second projection data P4).

The value of the loss function F34 may be determined based on the value of the first loss function F3 and the value of the second loss function F4. For example, the value of the loss function F34 may be a sum or a weighted sum of the first loss function F3 and the second loss function F4. After the value of the loss function F34 is determined, the processing device 200 may further update the updated preliminary model M2′ to be used in a next iteration based on the value of the loss function F34. In some embodiments, the processing device 200 may only determine the value of the second loss function F4 and further update the updated preliminary model M2′ based on the value of the second loss function F4 to be used in the next iteration. In some embodiments, a goal of the model parameter adjustment of the training of the preliminary model M2 may include minimizing a difference between the prediction output and the corresponding gold standard data, that is, minimizing the value of the second loss function F4. In some embodiments, a goal of the model parameter adjustment of the training of the preliminary model M2 may include minimizing a difference between the sum of the values of the respective elements in intermediate convolution kernel C′2 and the preset value b, that is, minimizing the value of the first loss function F3.

In some embodiments, the crosstalk calibration model may be generated by training the preliminary model using a model training technique, e.g., a gradient descent technique, a Newton technique, etc. In some embodiments, if a preset stop condition is satisfied in a certain iteration for updating the preliminary model M2, the training of the preliminary model M2 may be completed. The preset stop condition may include a convergence of the loss function F34 or the second loss function F4 (for example, the difference between the values of the loss function F34 in two consecutive iterations or the values of the second loss function F4 in two consecutive iterations smaller than a first threshold) or the result of the loss function F34 or the second loss function F4 smaller than a second threshold, a count of the iterations in the training exceeding a third threshold, etc.

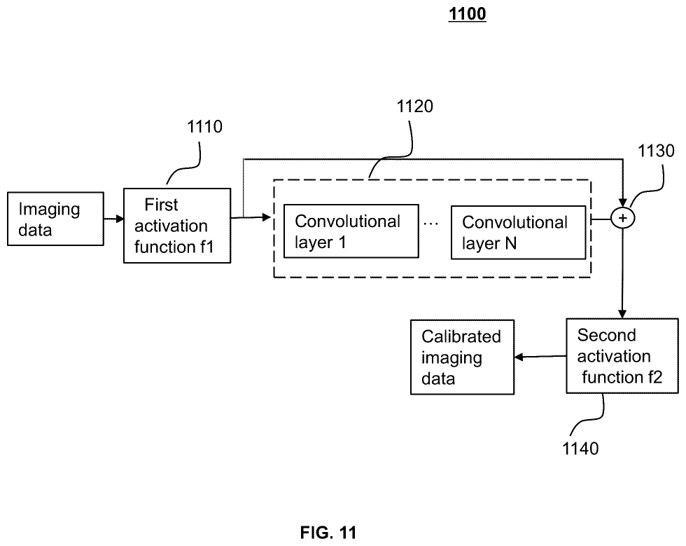

FIG. 11 is a schematic diagram illustrating a crosstalk calibration model 1100 according to some embodiments of the present disclosure. As shown in FIG. 11, the crosstalk calibration model 1100 may include at least one convolution layer 1120. The at least one convolution layer 1120 may include at least one candidate convolution kernel. The crosstalk calibration model may also include a first activation function f1-1110 and a second activation function f2-1140. The first activation function f1-1110 may be used to transform imaging data (e.g., projection data) being input to the crosstalk calibration model into data of a target type, which may be input to the at least one convolutional layer 1120 for processing. The second activation function f2-1140 may be used to transform output data of the at least one convolutional layer 1120 from the data of the target type to required imaging data (e. g., projection data), and the required imaging data may be used as output data of the crosstalk calibration model 1100 (i.e., calibrated imaging data). The data of the target type may be data of any desired type, for example, data in an intensity domain (such as a radiation intensity I). The first activation function F1 and the second activation function F2 may be any activation function with a reversible capability, such as a rectified linear unit (ReLu), a hyperbolic tangent function (tanh), an exponential function (exp), etc. The first activation function F1 and the second activation function F2 may be inverse to each other. For example, the first activation function F1 may be an exponential transformation function (exp (x)), and the second activation function F2 may be a logarithmic transformation function (log(y)).

In some embodiments, the crosstalk calibration model 1100 may also include a fusion unit 1130. The fusion unit 1130 may be configured to fuse the input data and the output data of the at least one convolution layer to determine first fusion data, and the first fusion data may be input to the second activation function f2-1140. The second activation function f2-1140 may determine the output data of the crosstalk calibration model 1100 (i.e., the calibrated imaging data) based on the first fusion data.

In 820, the processing device 200 may determine a target convolution kernel C2 based on the at least one candidate convolution kernel of the crosstalk calibration model. In some embodiments, operation 820 may be performed by the kernel determination module 220.

A target convolution kernel determined based on the at least one candidate convolution kernel of the crosstalk calibration model may be referred to as the target convolution kernel C2. The method for determining the target convolution kernel based on the at least one candidate convolution kernel of a calibration model may be found in operation 320 and the descriptions thereof, which are not repeated here.

In 830, the processing device 200 may determine crosstalk information of the target imaging device based on the target convolution kernel C2. In some embodiments, operation 830 may be performed by the information determination module 230.

In some embodiments, the crosstalk information may include crosstalk information between the target detection unit and at least one other detection unit surrounding the target detection unit (e.g., at least one other detection unit in the detection unit matrix corresponding to the target detection unit). In some embodiments, the crosstalk information may include crosstalk information between the target detection unit and the at least one other detection units in one or more directions.

In some embodiments, the crosstalk information may include a crosstalk coefficient. The crosstalk coefficient may be used to measure the amount of the crosstalk between detection units. For example, a crosstalk coefficient of a detection unit with respect to the target detection unit may represent a proportion of a radiation intensity that should be acquired by the detection unit but allocated to the target detection unit. A crosstalk coefficient of the target detection unit with respect to another detection unit may represent a proportion of a radiation signal (e.g., a radiation intensity) that should be acquired by the target detection unit and but allocated to another detection unit.

For example, FIG. 10 shows a detection unit matrix 1010 corresponding to the target detection unit N. Nine detection units 1, 2, 3, 4, 5, 6, 7, 8, and N may form a 3×3 detection unit matrix. If the detection unit 2 allocates 0.4% radiation signals to the target detection unit N, a crosstalk coefficient of the detection unit 2 with respect to the target detection unit N may be 0.4%. If the target detection unit N allocates 2.8% radiation signals to the 8 the adjacent detection units 1˜8, a crosstalk coefficient of the target detection unit N with respect to other detection units 1˜8 may be −2.8% (a negative crosstalk coefficient may indicate that the detection unit allocates its own signal to surrounding detection units).

As mentioned above, the trained crosstalk calibration model (including at least one candidate convolution kernel) may be configured to calibrate the deviation projection data caused by the crosstalk. The calibration of the deviation projection data by the crosstalk calibration model may be mainly realized based on the at least one candidate convolution kernel. Therefore, the at least one candidate convolution kernel of the crosstalk calibration model may be used to determine information relating to the crosstalk calibration. Some embodiments of the present disclosure may determine the target convolution kernel C2 based on the at least one candidate convolution kernel, and determine the crosstalk information of the target imaging device based on the target convolution kernel C2. In some embodiments, the greater the count of the candidate convolution kernel(s) included in the crosstalk calibration model is, the more accurate the information relating to the crosstalk calibration included in the target convolution kernel C2 that is determined based on the at least one candidate convolution kernel, and the better effect of the crosstalk calibration based on the target convolution kernel C2 may be. Some embodiment provided in the present disclosure may use the deep learning technique to learn the calibration process of the deviation projection data, which has higher calibration accuracy and efficiency than the traditional calibration technique.

In some embodiments, the processing device 200 may determine crosstalk coefficient(s) between the target detection unit and at least one other detection unit in at least one direction (e. g., the directions X, Y, c1, c2 shown in FIG. 10). For example, the crosstalk information may include a crosstalk coefficient 0.4% of an adjacent detection unit 4 with respect to the target detection unit N in the negative axis of the direction X (i.e., the left), and a crosstalk coefficient 0.4% of an adjacent detection unit 5 with respect to the target detection unit N in the positive axis of the direction X (i.e., the right).

FIG. 10 shows the target convolution kernel C2-1020 and the crosstalk information 1030 simultaneously. The principle and method for determining the crosstalk information of the target detection unit N based on the target convolution kernel C2-1020 may be described below in combination with FIG. 10. As shown in FIG. 10, there may be crosstalk between the target detection unit N and the surrounding detection units 1˜8. The size of the target convolution kernel C2-1020 determined based on the crosstalk calibration model may be the same as that of the detection unit matrix 1010 in FIG. 10, both being 3×3. As shown in FIG. 10, the determined target convolution kernel C2-1020 may include elements k, k1, k2, k3, k4, k5, k6, k7, and k8, and a central element is k. Each element of the target convolution kernel C2-1020 may correspond to a detection unit of the detection unit matrix 1010 at the same position. In the target convolution kernel C2-1020 shown in FIG. 10, the central element k may correspond to the central target detection unit N, and the other detection units 1˜8 may correspond to the elements k1˜k8, respectively. Actual response values of the detection units 1, 2, 3, 4, 5, 6, 7, 8, and N may be represented as VaI₁, VaI₂, VaI₃, VaI₄, VaI₅, VaI₆, VaI₇, VaI₈, VaI_{N}, respectively. When there is no crosstalk between the target detection unit N and the other surrounding detection units, an ideal response value of the target detection unit N may be expressed as VaI_{N}′. The detection unit matrix 1010 in FIG. 10 may include the direction X, the direction Y, the direction c1, and the direction c2. The directions c1 and c2 may be diagonal directions of the detection unit matrix 1010 in FIG. 10.

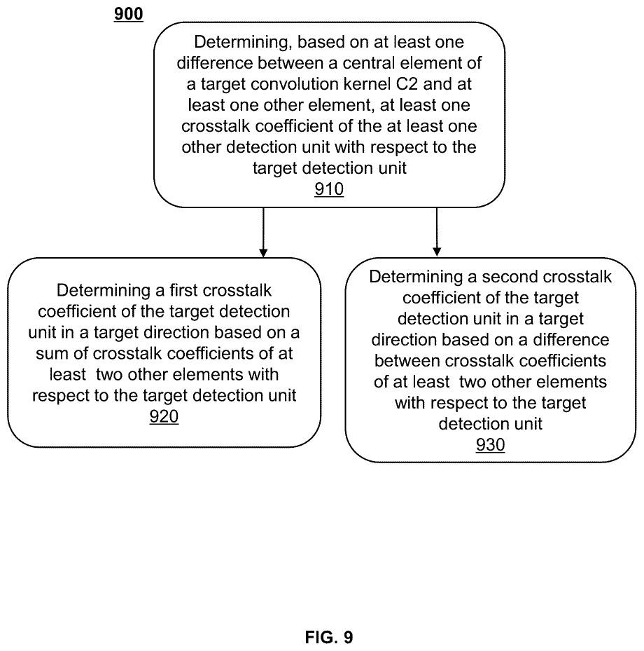

In some embodiments, the process 900 shown in FIG. 9 may be performed to determine the crosstalk information based on the target convolution kernel C2. The implementation process of the process 900 may be described below in combination with FIG. 10.

In 910, the processing device 200 may determine, based on at least one difference between the central element of the target convolution kernel C2 and at least one other element, at least one crosstalk coefficient of the at least one other detection unit with respect to the target detection unit. In some embodiments, operation 910 may be performed by the information determination module 230.

For example, if a difference between the central element k and the element k7 of the target convolution kernel C2 is (k7−k), a crosstalk coefficient of the detection unit 7 corresponding to the element k7 with respect to the target detection unit N may be (k7−k). In some embodiments, crosstalk coefficient(s) of the at least one other detection unit with respect to the target detection unit in at least one direction may be determined. The at least one direction may refer to at least one direction in an element array of the target convolution kernel C2, or at least one direction in the detection unit matrix, for example, the directions X, Y, c1, or c2 shown in FIG. 10. For example, crosstalk coefficients of the detection units 2 and 7 with respect to the target detection unit in the direction Y may be determined as (k7−k) and (k−k2), respectively.

In 920, the procession device 200 may determine a first crosstalk coefficient of the target detection unit in a target direction based on the crosstalk coefficient(s). In some embodiments, operation 920 may be performed by the information determination module 230.

The first crosstalk coefficient corresponding to the target direction may be used to measure a sum of the crosstalk degrees of other detection units with respect to the target detection unit in the target direction.

In some embodiments, the first crosstalk coefficient of the target detection unit in the target direction may be determined based on a sum of crosstalk coefficients of the remaining detection units with respect to the target detection unit in the target direction. Taking FIG. 10 as an example, crosstalk coefficients of the detection units 2 and 7 with respect to the target detection unit N in the direction Y may be (k7−k) and (k−k2), respectively, and the first crosstalk coefficient in the direction Y may be the sum ((k7−k)+(k−k2))=(k7−k2)) of the crosstalk coefficients of the other detection units with respect to the target detection unit.

Crosstalk coefficients of the other detection units with respect to the target detection unit in other directions may be determined similar to the first crosstalk coefficient. Further, a first-order crosstalk coefficient of the target detection unit may be determined based on the first crosstalk coefficients in various directions. The first-order crosstalk coefficient of the target detection unit may be determined based on a sum of the crosstalk between the target detection unit and the other detection units in various directions, and represent an average level of the crosstalk in various directions. For example, the first-order crosstalk coefficient of the target detection unit N may be determined by the formula:

$$\frac{1}{4} ( {k}_{5} + {k}_{7} + {k}_{6} + {k}_{8} - {k}_{4} - {k}_{2} - {k}_{3} - {k}_{1} ) .$$

In 930, the processing device 200 may determine a second crosstalk coefficient of the target detection unit in the target direction based on crosstalk coefficients of at least two other elements with respect to the target detection unit. In some embodiments, operation 930 may be performed by the information determination module 230.

The second crosstalk coefficient corresponding to the target direction may measure a difference of crosstalk degrees of different other detection units with respect to the target detection unit in the target direction, or a change of crosstalk existing in the target detection unit of the target direction.

In some embodiments, the second crosstalk coefficient of the target detection unit in the target direction may be determined based on a difference between crosstalk coefficients of the remaining detection units with respect to the target detection unit in the target direction. Taking FIG. 10 as an example, if the crosstalk coefficients of the detection units 2 and 7 with respect to the target detection unit N in the direction Y are (k₇−k) and (k−k₂), respectively, the second crosstalk coefficient in the direction Y may be the difference ((k₇−k)−(k−k₂))=(k₇+k₂−2k)) between the crosstalk coefficients of the other detection units with respect to the target detection unit. The difference between crosstalk coefficients of other detection units with respect to the target detection unit in other directions may also be determined similar to the second crosstalk coefficient. Further, a second-order crosstalk coefficient of the target detection unit may be determined based on the second crosstalk coefficients in various directions. The second-order crosstalk coefficient of the target detection unit may represent a changing trend of the crosstalk between the target detection unit and multiple other detection units in each direction. For example, the second crosstalk coefficient of the target detection unit N may be determined according to the formula:

$$\frac{1}{4} ( {\sum }_{i = 1}^{8} {k}_{i} - 8 k ) .$$

In some embodiments, the target imaging device may scan and image an object (e. g., a patient) to acquire projection data including deviation projection data caused by the crosstalk of the target imaging device. The processing device 200 may calibrate the deviation projection data caused by the crosstalk according to the determined crosstalk information. For example, the processing device 200 may determine an ideal response value (e.g., an ideal projection value) of the target detection unit based on the crosstalk information of the target detection unit and actual response values (e.g., actual projection values) of the target detection unit and the remaining detection units. As used herein, the actual response value of the detection unit may be a response value (e.g., a projection value) generated by a ray actually received by the target detection unit. The ideal response value of the detection unit may be a response value generated by a ray received by the detection unit in an ideal condition of no crosstalk.

In some embodiments, the ideal response value of the target detection unit may be determined based on the actual response value of the target detection unit, the actual response values of other detection units, and the first-order crosstalk coefficient of the target detection unit. For example, the ideal response value of the target detection unit may be determined according to the formula:

$$\frac{1}{4} ( {Val}_{5} + {Val}_{7} + {Val}_{6} + {Val}_{8} - {Val}_{4} - {Val}_{2} - {Val}_{3} - {Val}_{1} ) * α + {Val}_{N} ,$$

wherein α represents the first-order crosstalk coefficient of the target detection unit.

In some embodiments, the ideal response value of the target detection unit may be determined based on the actual response value of the target detection unit, the actual response values of other detection units, and the second-order crosstalk coefficient of the target detection unit. For example, the ideal response value of the target detection unit may be determined according to the formula:

$$\frac{1}{4} ( {\sum }_{i = 1}^{8} {Val}_{i} - 8 {Val}_{N} ) * β + {Val}_{N} ,$$

wherein β represents the second-order crosstalk coefficient of the target detection unit.

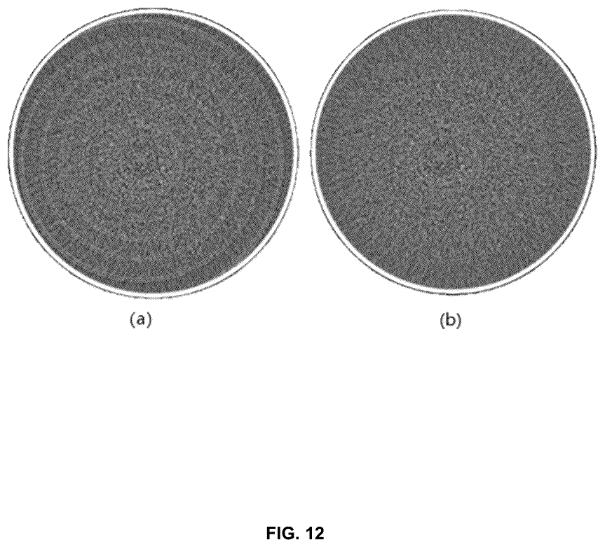

In some embodiments, the processing device 200 may separately designate each detection unit of the target imaging device as the target detection unit to determine an ideal response value (e. g., an ideal projection value) thereof. The processing device 200 may determine calibrated imaging data (e. g., calibrated projection data) based on the ideal response value of each detection unit. In some embodiments, the calibrated imaging data may be used for image reconstruction to generate a scanned image of the object. Merely by way of example, as shown in FIG. 12, (a) is a schematic diagram of an image reconstructed based on original projection data acquired by the target imaging device, and (b) is a schematic diagram of an image reconstructed based on projection data after the crosstalk calibration. It can be seen that after the crosstalk calibration, the image (b) is more uniform and clear, and has higher quality.

FIG. 13 is a flowchart illustrating a calibration method of an imaging device according to some embodiments of the present disclosure. In some embodiments, one or more operations of the process 1300 shown in FIG. 13 may be implemented in the calibration system 100 shown in FIG. 1. For example, the process 1300 shown in FIG. 13 may be stored in a storage medium of the first computing system 120 and/or the second computing system 130 in the form of instructions and revoked and/or executed by a processing device of the first computing system 120 and/or the second computing system 130. In some embodiments, the process 1300 shown in FIG. 13 may be executed by the processing device 200 shown in FIG. 2. For illustration purposes, the processing device 200 may be used as an example to describe the execution of the process 1300 below.

In some embodiments, the process 1300 may be executed for a plurality of detection units of a target imaging device, respectively, to calibrate projection data acquired by each detection unit. For illustration purposes, how to perform the process 1300 on a target detection unit of the target imaging device may be described below.

In 1310, the processing device 200 may acquire a scattering calibration model of the target imaging device. In some embodiments, operation 1310 may be performed by the model obtaining module 210.

The scattering may refer to a phenomenon that a part of a radiation beam deviates from its original direction and propagates dispersedly when the radiation beam passes through an inhomogeneous medium or interface. When the object is scanned and imaged by the target imaging device, the scattering may occur. The scattering may include defocusing (also referred to as scattering of a focal point) and ray scattering. Ideally, a ray source of the target imaging device should radiate a ray outward from a focal point. However, due to a shake of an X-ray tube or other reasons, the ray source may radiate rays outwardly from a position other than the focal point, resulting in that a part of the rays that should to be radiated outwardly from the focal point of the ray source being dispersed to be radiated outwardly from other regions other than the focal point. Such a phenomenon may be referred to as the scattering of the focal point or defocusing. The focal point (also referred to as a main focal point) of the ray source of the target imaging device may correspond to a detection unit, and the detection unit may be referred to as a focal point detection unit (also referred to as a main focal point detection unit).

The ray scattering may refer that a ray of the target imaging device is scattered when penetrating a scanned object, and then deviates from its original propagation direction. The defocusing and the ray scattering may cause a deviation of projection data acquired by one or more detection units of the detector, resulting in inaccuracy of an imaged image or causing an artifact. For example, the defocusing may cause a part of the projection data that should be acquired by the focal point detection unit to be dispersed into one or more surrounding detection units.

In some embodiments, the scattering calibration model may refer to a model configured to calibrate deviation projection data caused by the scattering in the projection data acquired by the target imaging device. In some embodiments, the scattering calibration model may include a defocusing calibration model configured to calibrate deviation projection data caused by the defocusing in the projection data acquired by the target imaging device. In some embodiments, the scattering calibration model may include a ray scattering calibration model configured to calibrate deviation projection data caused by the ray scattering of the object in the projection data acquired by the target imaging device. In some embodiments, the scattering calibration model may be configured to calibrate deviation projection data acquired by a target detection unit and caused by the scattering (e. g., the defocusing or the ray scattering).

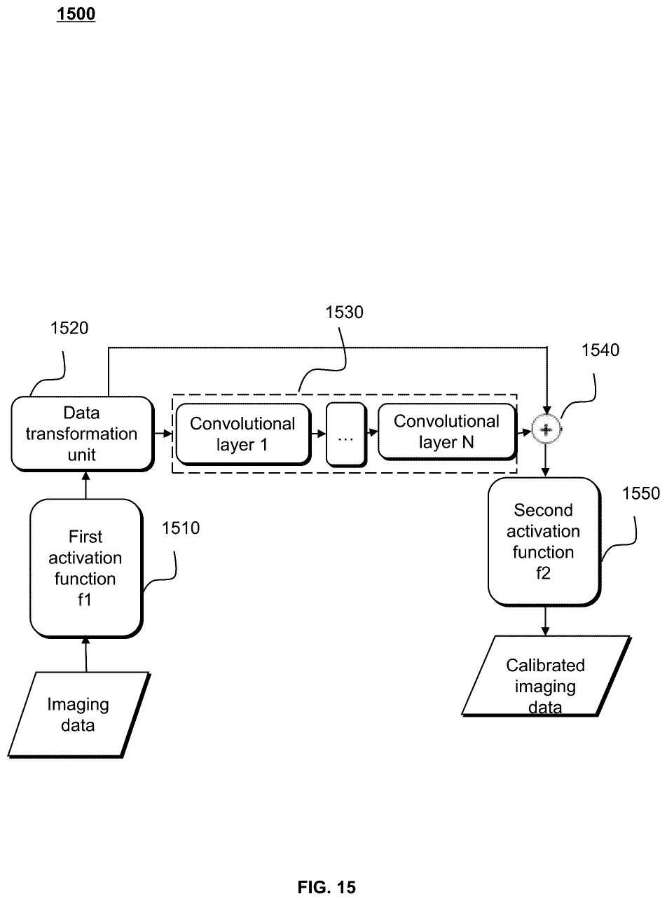

FIG. 15 is a schematic diagram illustrating a defocusing calibration model 1500 according to some embodiments of the present disclosure. As shown in FIG. 15, the defocusing calibration model 1500 may include a first activation function f1-1510, a data transformation unit 1520, at least one convolution layer 1530, a data fusion unit 1540, and a second activation function f2-1550.

The first activation function f1-1510 may be used to transform imaging data input into the defocusing calibration model 1500 into data of a target type. The data of the target type may be input into the at least one convolutional layer 1530 for processing. The second activation function f2-1550 may be used to transform output data of the at least one convolutional layer 1530 from the data of the target type to required imaging data (e.g., projection data) to acquire output data of the defocusing calibration model 1500, that is, calibrated imaging data (e. g., calibrated projection data). The first activation function f1-1510 may be similar to the first activation function f1-1110 in FIG. 11, and the second activation function f2-1550 may be similar to the second activation function f2-1140 in FIG. 11, which are not repeated here.

The data transformation unit 1520 may be used to transform the data of the target type output by the first activation function f1-1510 to acquire transformed data, and the transformed data may be input into the at least one convolutional layer 1530 for processing. In some embodiments, the transformation operation of the data transformation unit 1510 may include performing a data rotation operation on the data of the target type to acquire the transformed data. In some embodiments, the data rotation operation may be equivalent to determining detection units corresponding to various rotation angles view. More descriptions of the detection unit corresponding to each rotation angle view may refer to formula (5).

The fusion unit 1520 may be similar to the fusion unit 1130 shown in FIG. 11, and configured to fuse the input data and output data of the at least one convolutional layer 1530 to acquire second fusion data. The second fusion data may be input into the second activation function f2-1550, and the second activation function f2-1550 may determine the output data of the defocusing calibration model 1500 based on the second fusion data. In some embodiments, the fusion processing of the fusion unit 1520 may be represented as I_{corr}=I+ΔI, where I_{corr}, is intensity data after the scattering calibration (i.e., the output data of the defocusing calibration model 1500), I is intensity data input into the at least one convolutional layer 1530, and ΔI is intensity data output by the at least one convolutional layer 1530.

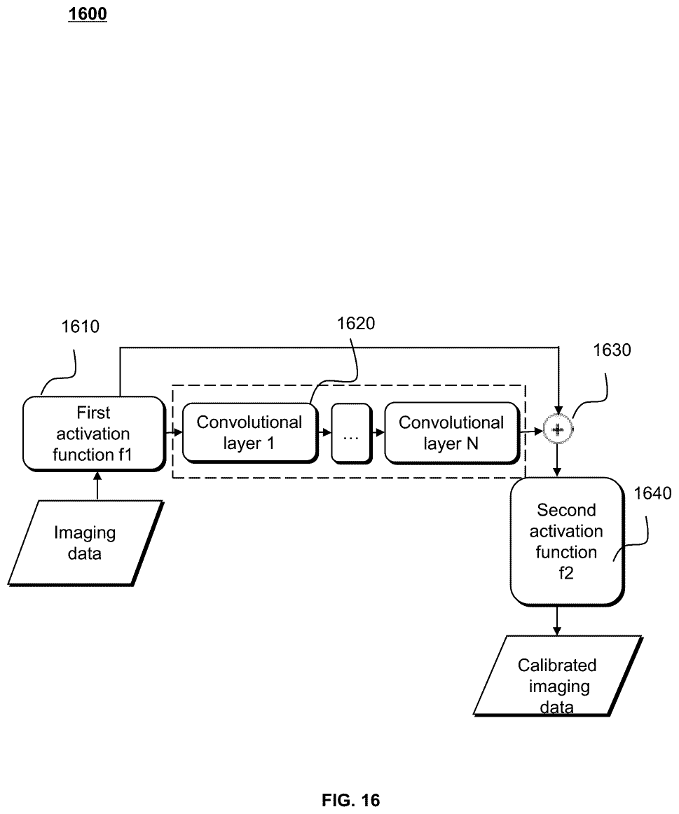

FIG. 16 is a schematic diagram illustrating a scattering calibration model 1600 according to some embodiments of the present disclosure. As shown in FIG. 16, the scattering calibration model 1600 may include a first activation function f1-1610, at least one convolution layer 1620, a data fusion unit 1630, and a second activation function f2-1640. The scattering calibration model 1600 may be similar to the defocusing calibration model 1500, except that the scattering calibration model 1600 excludes the data transformation unit in the defocusing calibration model 1500.

In some embodiments, the scattering calibration model may be pre-generated by the processing device 200 or other processing devices. For example, the processing device 200 may acquire projection data P5 and projection data P6 of a reference object. Further, the processing device 200 may determine training data S3 based on the projection data P5 and the projection data P6, and train a preliminary model M3 based on the training data S3 to generate the scattering calibration model (e. g., a defocusing calibration model or a ray scattering calibration model).

The projection data P5 may include projection data acquired by the target imaging device by scanning the reference object. For example, the projection data P3 may include projection data acquired by a detection unit matrix corresponding to the target detection unit of the target imaging device. Due to the scattering of the target imaging device, the projection data P5 may include the deviation projection data caused by the scattering of the target imaging device (e. g., defocusing or ray scattering of the object).

The projection data P6 may include projection data acquired by a standard imaging device 3 by scanning the reference object. For example, the projection data P6 may include projection data acquired by a detection unit matrix corresponding to a standard detection unit of the standard imaging device 3. The position of the standard detection unit may be the same as that of the target detection unit of the target imaging device, and the size and structure of the detection unit matrix of the standard detection unit may be the same as the size and structure of the detection unit matrix of the target detection unit. In the present disclosure, the standard imaging device 3 may be an imaging device without crosstalk or having crosstalk within an acceptable range. For example, the standard imaging device 3 may be equipped with some anti-scattering elements (e. g., a collimator, an anti-scattering grating, etc.).

In some embodiments, the target imaging device and the standard imaging device 3 may be the same type. In some embodiments, the projection data P5 and the projection data P6 are acquired by the same scanning manner. Detailed descriptions of the same scanning manner may be found in FIG. 5 and the descriptions thereof.

In some embodiments, the target imaging device with scattering may scan the reference object multiple times to acquire the projection data P5 relating to each detection unit in the detector. In some embodiments, the standard imaging device 3 may also scan the reference object multiple times to acquire the projection data P6 relating to each detection unit in the detector. Detailed descriptions of the multiple scans may be found in FIG. 5 and the descriptions thereof.

In some embodiments, the projection data P5 and/or the projection data P6 may be acquired based on an existing calibration technique or a simulation technique. For example, the reference object may be scanned by an imaging device (such as a target imaging device or other imaging devices with scattering) including scattering (such as defocusing or ray scattering of the object) to acquire the projection data P5, and the corresponding projection data P6 may be determined based on the projection data P5 using the existing calibration technique or simulation technique. For example, the reference object may also be scanned by the standard imaging device 3 to acquire the projection data P6, and the corresponding projection data P5 may be determined based on the projection data P6 using the existing calibration technique or simulation technique.

In some embodiments, the training of the preliminary model M3 (such as a preliminary model corresponding to the defocusing calibration model or a preliminary model corresponding to the ray scattering calibration model) with the projection data P5 and the projection data P6 as the training data may include one or more iterations. In the one or more iterations, the processing device 200 may designate the projection data P5 as the model input, designate the projection data P6 as the gold standard data, and iteratively update a model parameter of the preliminary model M3. For example, in a current iteration, the processing device 200 may determine an intermediate convolution kernel C′3 of the updated preliminary model M3′ generated in a previous iteration. It should be noted that if the current iteration is a first iteration, the processing device 200 may determine an intermediate convolution kernel of the preliminary model M3. The intermediate convolution kernel C′3 may be determined based on at least one candidate convolution kernel of the preliminary model M3 or the updated preliminary model M3′. The method for determining the intermediate convolution kernel based on the candidate convolution kernel(s) of the preliminary model M3 or the updated preliminary model M3′ may be similar to the method for determining the target convolution kernel based on the candidate convolution kernel(s) of the calibration model. See, FIG. 3 and the descriptions thereof.

The processing device 200 may further determine a value of a loss function F56 based on the first projection data P5, the second projection data P6, and the intermediate convolution kernel C′3. In some embodiments, the processing device 200 may determine a value of a first loss function F5 based on the intermediate convolution kernel C′3. The processing device 200 may determine a value of a second loss function F6 based on the first projection data P5 and the second projection data P6. Further, the processing device 200 may determine the value of the loss function F56 based on the value of the first loss function F5 and the value of the second loss function F6.

For example, the first loss function F5 may be used to measure a difference between an element value of a central element of the intermediate convolution kernel C′3 and a preset value c. The central element of the intermediate convolution kernel C′3 may refer to an element at a central position of the intermediate convolution kernel C′3. In some embodiments, the preset value c may be 1. In some embodiments, the difference between the element value of the central element of the intermediate convolution kernel C′3 and the preset value c may include an absolute value, a square difference, etc., of the difference between the element value of the central element and the preset value c. The second loss function F6 may be used to measure a difference between a predicted output of the updated preliminary model M3′ (i.e. the output after the projection data P5 is input into M3′) and the corresponding gold standard data (i.e. the corresponding projection data P6).

The value of the loss function F56 may be determined based on the value of the first loss function F5 and the value of the second loss function F6. For example, the value of the loss function F56 may be a sum or a weighted sum of the first loss function F5 and the second loss function F6. After the value of the loss function F56 is determined, the processing device 200 may further update the updated preliminary model M3′ to be used in a next iteration based on the value of the loss function F56. In some embodiments, the processing device 200 may only determine the value of the second loss function F6 and further update the updated preliminary model M3′ to be used in the next iteration based on the value of the second loss function F6. In some embodiments, the goal of the model parameter adjustment of the training of the preliminary model M3 may include minimizing a difference between the prediction output and the corresponding gold standard data, that is, minimizing the value of the second loss function F6. In some embodiments, the goal of the model parameter adjustment of the training of the preliminary model M3 may include minimizing the difference between the element value of the central element of the intermediate convolution kernel C′3 and the preset value c, that is, minimizing the value of the first loss function F5.

In some embodiments, the scattering calibration model may be generated by training the preliminary model using a model training technique, for example, a gradient descent technique, a Newton technique, etc. In some embodiments, if a preset stop condition is satisfied in a certain iteration for updating the preliminary model M3, the training of the preliminary model M3 may be completed. The preset stop condition may include a convergence of the loss function F56 or the second loss function F6 (for example, a difference between the values of the loss function F56 in two consecutive iterations or the values of the second loss function F6 in two consecutive iterations smaller than a first threshold) or the result of the loss function F56 or the second loss function F6 smaller than a second threshold, a count of the iterations in the training exceeding a third threshold, etc.

In 1320, the processing device 200 may determine the target convolution kernel C3 based on at least one candidate convolution kernel of the scattering calibration model. In some embodiments, operation 1320 may be performed by the kernel determination module 220.

A target convolution kernel determined based on the at least one candidate convolution kernel of the scattering calibration model (such as the defocusing calibration model or the ray scattering calibration model) may be referred to as the target convolution kernel C3. More descriptions of the method for determining the target convolution kernel based on the at least one candidate convolution kernel of the model may be found in FIG. 3 and the description thereof, which are not be repeated here.

As mentioned above, the trained scattering calibration model (including at least one candidate convolution kernel) may be used to calibrate the deviation projection data caused by the scattering. The calibration of the deviation projection data by the scattering calibration model may be mainly realized based on the at least one candidate convolution kernel. Therefore, the at least one candidate convolution kernel in the scattering candidate model may be used to determine information relating to the scattering calibration. Some embodiments of the present disclosure may determine the target convolution kernel C3 based on the at least one candidate convolution kernel, and determine the scattering information of the target imaging device based on the target convolution kernel C3. In some embodiments, the greater the count of the candidate convolution kernel(s) included in the scattering calibration model is, the more accurate the information relating to the scattering calibration included in the target convolution kernel C3 that is determined based on the at least one candidate convolution kernel may be, and the better effect of the scattering calibration based on the target convolution kernel C3 may be. Some embodiments provided in the present disclosure may use the deep learning technique to learn the calibration process of the deviation projection data, which has higher calibration accuracy and efficiency than the traditional calibration technique.

In some embodiments, the target convolution kernel C3 may include 0 elements and non-zero elements (for example, in the target convolution kernel, only elements on a diagonal line have a non-zero value, and values of the other elements are 0). A non-zero element of the target convolution kernel C3 may be referred to as a target element. The position of the target element in the target convolution kernel C3 may relate to a rotation angle of multiple scans of an imaging of the target imaging device. The position of the target element may be determined based on a model parameter of the scattering calibration model. For example, the parameters of the data transformation unit 1520 of the scattering calibration model may include the direction of data rotation operation (data rotation operation may refer to the direction in which the input data of the data transformation unit 1520 is rotated, and the detection unit corresponding to each rotation angle view can be determined based on the data rotation operation), and the position of the target element can be determined based on the direction of the data rotation operation (for example, if the direction of the data rotation operation is a 45-degree angular direction or a direction with a slope of 1, then the target convolution kernel C3 is in a 45-degree angular direction or a slope. Another example, the position of the target element may be determined based on a position of the non-zero element of the candidate convolution kernel of the scattering calibration model. In some embodiments, the value of the target element may be determined based on the method for determining the value of the element in the target convolution kernel in FIG. 3, and the target convolution kernel C3 may be determined based on the value of the target element. In some embodiments, the size of the target convolution kernel C3 corresponding to the scattering calibration model (e. g., a defocusing calibration model, a scattering calibration model) may be determined based on a scattering range (e. g., a scattering range corresponding to defocusing or ray scattering). An imaging performed by the target imaging device may include multiple scans. A rotation angle (referring to a deviation angle of a scanning angle of a later scan relative to a scanning angle of a previous scan) may be determined for the imaging. In each scan of the multiple scans of the imaging, the target imaging device may rotate based on the rotation angle. As shown in FIG. 14, a defocusing angle of an X-ray tube of the target imaging device is 5°, and the rotation angle of the target imaging device may be 0.5° during each scanning. A main focal point F11 may be discretized into 10 defocusing focal points F1-F10. Point A (at the box) is a point of the scanned object. 1-12 are 12 detection units, of which the focal point detection unit is the detection unit 6. For the point A of the object, a ray emitted by the defocusing focal point F1 is received by the detection unit 10 by passing the point A, and a signal generated so may be a signal scattered from the focal point detection unit 6 to the detection unit 10. Scattered signals of the remaining defocusing focal points may be received by remaining detection units other than the detection unit 6 similarly. It can be seen that a scattering range of the scattering of the focal point is 10 detection units, and the length of the corresponding target convolution kernel C3 may be determined as 5°/0.5°=10 (for example, the size of the target convolution kernel C3 is 1×10 or 10×10). Similar to FIG. 14, a ray scattering angle of the target imaging device may be 5°, the rotation angle of the target imaging device may be 0.5° during each scanning, and the detection unit 6 may be used as the target detection unit. Due to the ray scattering, the ray deemed to be received by the target detection unit 6 may be received by other detection units. It can be seen that the ray scattering range may be 10 detection units, and the length of the corresponding target convolution kernel C3 may be determined as 5°/0.5°=10 (for example, the size of the target convolution kernel C3 is 1×10 or 10×10).

In 1330, the processing device 200 may determine scattering information of the target imaging device based on the target convolution kernel C3. In some embodiments, operation 1330 may be performed by the information determination module 230.

In some embodiments, the scattering information may include focal point scattering information and/or ray scattering information of the target detection unit. In some embodiments, the scattering information may include a scattering convolution kernel used to calibrate the deviation projection data caused by the scattering. The scattering convolution kernel may represent a scattering distribution of the detection unit matrix. The calibrated projection data may be determined by performing a convolution operation based on the scattering convolution kernel and the acquired projection data. A traditional method may usually use a measurement technique or a theoretical simulation technique to determine the scattering convolution kernel. However, the measurement technique may be easily affected by a measurement equipment and noise while the theoretical simulation technique may be based on a large amount of data approximation and assumption, and the accuracy of the determined scattering convolution kernel may be relatively low. The present disclosure may designate the target convolution kernel C3 determined based on the scattering calibration model as the scattering convolution kernel. The scattering calibration model may learn the process for calibrating the projection data based on a big data technique. The target convolution kernel C3 (i.e., the scattering convolution kernel) determined based on the scattering calibration model may have higher accuracy and reliability.

In some embodiments, the scattering information may include scattering coefficients of the target detection unit with respect to other detection units. A scattering coefficient may represent a proportion of a signal scattering of the target detection unit in another detection unit. In some embodiments, element values in the target convolution kernel C3 may represent scattering coefficients of other detection units at corresponding positions in the detection unit matrix with respect to the target detection unit.

In some embodiments, the target imaging device may scan and image an object (e. g., a patient) to acquire projection data. The projection data may include deviation projection data caused by a scattering phenomenon. The processing device 200 may calibrate the scattering of the projection data acquired by the target detection unit based on the scattering information corresponding to the target detection unit.

In some embodiments, when the scattering includes the scattering of the focal point, the processing device 200 may acquire the calibrated projection data of the target detection unit using the method described below. In a first step, actual projection data p of the target detection unit may be transformed into actual intensity data I using the first activation function f1. For example, the following function f1 may be used: I=e^{-p}.

In a second step, based on the determined target convolution kernel C3 or the scattering coefficients between other detection units and the target detection unit, the actual intensity data I of the target detection unit may be convoluted as shown in formula (5) to determine calibrated scattering intensity data of the target detection unit

ΔI=Σ_{view}I(chan_{view},view)*kernel(view), (5)

chan represents a detection unit channel corresponding to the detection units in the detection unit rows within a scattering range of the focal point; view represents the rotation angle, and each rotation angle corresponds to one other detection unit within the scattering range; chan_{view} represents calibration detection units corresponding to a defocusing signal at the rotation angle view (also referred to as a calibration channel corresponding to the defocusing signal at the rotation angle view); kernel represents the target convolution kernel C3; kernel(view) represents values of other elements, in the target convolution kernel C3, corresponding to calibration detection units at the rotation angle view (that is, scattering coefficients of calibration detection units corresponding to the rotation angle view); and (chan_{view}, view) represents actual intensity data of calibration detection units corresponding to the rotation angle view. The calibration detection units corresponding to a defocusing signal at the rotation angle view (also referred to as a calibration channel corresponding to the defocusing signal at the rotation angle view) may refer to other detection units that need to be used to calibrate projection data of the target detection unit in the rotation angle view.

In a third step, the determined calibrated scattering intensity data ΔI is superimposed on the actual intensity data I of the target detection unit to acquire the calibrated intensity data I_{corr} (i.e., ideal intensity data corresponding to the target detection unit after the scattering calibration). For example, the following formula may be used: I_{corr}=I+ΔI.

In a fourth step, the calibrated intensity data I_{corr} may be transformed into projection data using the second activation function f2 to acquire the calibrated projection data p_{corr} (i.e. ideal projection data corresponding to the target detection unit after the scattering calibration). For example, the following function f2 may be used: P_{corr}=−ln(I_{corr})

In some embodiments, when the scattering includes the ray scattering of the object, the processing device 200 may determine the calibrated projection data of the target detection unit using the method described below.

In a first step, actual projection data p of the target detection unit is converted into actual intensity data I using the first activation function f1. For example, the following function f1 may be used: I=e^{-p}.

In a second step, based on the determined target convolution kernel C3, the actual intensity data I of the target detection unit may be convoluted as shown in formula (6) to acquire the calibrated scattering intensity data of the target detection unit

ΔI=Σ_{slice}Σ_{chan}(chan,slice)*kernel (chan,slice), (6)

chan represents a detection unit channel corresponding to the detection units in the detection unit rows within a ray scattering range; kernel represents the target convolution kernel C3; kernel(chan, slice) represents elements corresponding to the detection unit channel chan in a detection unit row slice in the target convolution kernel C3; I(chan, slice) represents actual intensity data of the detection unit channel chan in the detection unit row slice in the target convolution kernel C3.

In a third step, the determined calibrated scattering intensity data ΔI may be superimposed on the actual intensity data I of the target detection unit to determine the calibrated intensity data I_{corr} (i.e., ideal intensity data corresponding to the target detection unit after the scattering calibration). For example, the following formula may be used: I_{corr}: I_{corr}=I+ΔI.

In a fourth step, the calibrated intensity data I_{corr} may be transformed into projection data using a function f2 to determine the calibrated projection data p_{corr} (i.e. ideal projection data corresponding to the target detection unit after the scattering calibration). For example, the following function may be used: p_{corr}=−ln(I_{corr}).

In some embodiments, the calibrated imaging data (e. g., the calibrated projection data) may be used for image reconstruction to determine a scanned image of the object.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure and are within the spirit and scope of the exemplary embodiments of this disclosure.

Meanwhile, certain terminology has been used to describe embodiments of the present disclosure. For example, the terms “one embodiment,” “an embodiment,” and/or “some embodiments” mean that a particular feature, structure, or characteristic described in connection with the embodiment is in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in smaller than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A calibration method for imaging field, comprising:
obtaining a calibration model of a target imaging device, wherein the calibration model includes at least one convolutional layer, the at least one convolutional layer includes at least one candidate convolution kernel;
determining a target convolution kernel based on the at least one candidate convolution kernel of the calibration model; and
determining calibration information of the target imaging device based on the target convolution kernel, wherein the calibration information is used to calibrate at least one of a device parameter of the target imaging device or imaging data acquired by the target imaging device.

2. The calibration method of claim 1, wherein the calibration information includes at least one of mechanical deviation information of the target imaging device, crosstalk information of the target imaging device, or scattering information of the target imaging device.

3. The calibration method of claim 1, wherein the determining the target convolution kernel based on the at least one candidate convolution kernel of the calibration model includes:
determining the target convolution kernel by convolving the at least one candidate convolution kernel.

4. The calibration method of claim 1, wherein the determining a target convolution kernel based on the at least one candidate convolution kernel of the calibration model includes:
determining an input matrix based on the size of the at least one candidate convolution kernel; and
determining the target convolution kernel by inputting the input matrix into the calibration model.

5. The calibration method of claim 1, wherein the calibration model is generated by a model training process, the model training process comprising:
obtaining first projection data of a reference object, wherein the first projection data is acquired by the target imaging device, and the first projection data includes deviation projection data;
obtaining second projection data of the reference object, wherein the second projection data excludes the deviation projection data;
determining training data based on the first projection data and the second projection data, and
generating the calibration model by training a preliminary model using the training data.

6. The calibration method of claim 5, wherein the generating the calibration model by training a preliminary model using the training samples includes one or more iterations, at least one of the one or more iterations comprising:
determining an intermediate convolution kernel of an updated preliminary model generated in a previous iteration;
determining a value of a loss function based on the first projection data, the second projection data, and the intermediate convolution kernel; and
further updating the updated preliminary model to be used in a next iteration based on the value of the loss function.

7. The calibration method of claim 6, wherein the determining a value of a loss function based on the first projection data, the second projection data, and the intermediate convolution kernel includes:
determining the value of the loss function based on at least one of a value of a first loss function and a value of a second loss function, wherein the value of the first loss function is determined based on the intermediate convolution kernel, and the value of the second loss function is determined based on the first projection data and the second projection data.

8. The calibration method of claim 1, the target imaging device including a detector, the detector including a plurality of detection units, and the calibration information including a positional deviation of a target detection unit among the plurality of detection units, wherein
the determining calibration information of the target imaging device based on the target convolution kernel includes:
determining at least one first difference between a central element of the target convolution kernel and at least one other element of the target convolution kernel;
determining at least one second difference between a projection position of the target detection unit and at least one projection position of at least one other detection unit of the detector; and
determining the positional deviation of the target detection unit based on the at least one first difference and the at least one second difference.

9. The calibration method of claim 1, wherein the target imaging device includes a radiation source, and the calibration information includes mechanical deviation information of the radiation source.

10. The calibration method of claim 1, the target imaging device including a detector, the detector including a plurality of detection units, and the calibration information including a crosstalk coefficient of a target detection unit among the plurality of detection units, wherein
the determining calibration information of the target imaging device based on the target convolution kernel includes:
determining, based on at least one difference between a central element of the target convolution kernel and at least one other element of the target convolution kernel, at least one crosstalk coefficient of the at least one other element with respect to the target detection unit.

11. The calibration method of claim 10, wherein the at least one other element includes at least two other elements in a same target direction, and the determining calibration information of the target imaging device based on the target convolution kernel further comprises:
determining a first crosstalk coefficient of the target detection unit in the target direction based on a sum of the crosstalk coefficients of the at least two other elements with respect to the target detection unit.

12. The calibration method of claim 11, wherein the determining calibration information of the target imaging device based on the target convolution kernel further includes:
determining a second crosstalk coefficient of the target detection unit in the target direction based on a difference between the crosstalk coefficients of the at least two other elements with respect to the target detection unit.

13. The calibration method of claim 1, the calibration information including scattering information of the target imaging device, wherein the determining calibration information of the target imaging device based on the target convolution kernel includes:
determining scattering information of the target imaging device corresponding to at least one angle of view based on the target convolution kernel.

14. The calibration method of claim 1, the calibration model also including a first activation function and a second activation function, wherein
the first activation function is used to transform input data of the calibration model from projection data to data of a target type, the data of the target type being input to the at least one convolutional layer for processing; and
the second activation function is used to transform output data of the at least one convolutional layer from the data of the target type to projection data.

15. The calibration method of claim 14, wherein the calibration model also includes a fusion unit, and the fusion unit is configured to fuse the input data and the output data of the at least one convolutional layer.

16. The calibration method of claim 14, the calibration information of the target imaging device including calibration information relating to defocusing of the target imaging device, wherein
the calibration model also includes a data transformation unit, wherein the data transformation unit is configured to transform the data of the first target type to determine transformed data, and the transformed data is input to the at least one convolutional layer for processing.

17. A calibration system for imaging field, comprising:
at least one storage medium storing a set of instructions;
at least one processor in communication with the at least one storage medium, when executing the stored set of instructions, the at least one processor causes the system to:
obtain a calibration model of a target imaging device, wherein the calibration model includes at least one convolutional layer, the at least one convolutional layer includes at least one candidate convolution kernel;
determine a target convolution kernel based on the at least one candidate convolution kernel of the calibration model; and
determine calibration information of the target imaging device based on the target convolution kernel, wherein the calibration information is used to calibrate at least one of a device parameter of the target imaging device and imaging data acquired by the target imaging device.

18. The calibration system of claim 17, wherein the calibration information includes at least one of mechanical deviation information of the target imaging device, crosstalk information of the target imaging device, or scattering information of the target imaging device.

19-20. (canceled)

21. The calibration system of claim 17, wherein the calibration model is generated by a model training process, the model training process comprising:
obtaining first projection data of a reference object, wherein the first projection data is acquired by the target imaging device, and the first projection data includes deviation projection data;
obtaining second projection data of the reference object, wherein the second projection data excludes the deviation projection data;
determining training data based on the first projection data and the second projection data, and
generating the calibration model by training a preliminary model using the training data.

22-31. (canceled)

32. A non-transitory computer readable medium including executable instructions, the instructions, when executed by at least one processor, causing the at least one processor to effectuate a method comprising:
obtaining a calibration model of a target imaging device, wherein the calibration model includes at least one convolutional layer, the at least one convolutional layer includes at least one candidate convolution kernel;
determining a target convolution kernel based on the at least one candidate convolution kernel of the calibration model; and
determining calibration information of the target imaging device based on the target convolution kernel, wherein the calibration information is used to calibrate at least one of a device parameter of the target imaging device and imaging data acquired by the target imaging device.
